(19) United States
(12) Patent Application Publication
(10) Pub. No.: US 2007/0281230 A1
(43) Pub. Date: Dec. 6, 2007

(54) Image-Receiving Sheet and Manufacturing Method Thereof, and Image-Forming Process and Image-Forming System for Electrophotography

(76) Inventors: Kazuhito Miyake, Shizuoka (JP); Masamichi Kobayashi, Shizuoka (JP); Yoshio Tani, Shizuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/592,511

(22) PCT Filed: Mar. 7, 2005
(86) PCT No.: PCT/JP05/04378

§ 371 Date: Jul. 13, 2007

(30) Foreign Application Priority Data
Mar. 12, 2004 (JP) 2004-071642
Aug. 30, 2004 (JP) 2004-250170

(51) Int. Cl. G03G 7/00; D21H 27/00; G03G 15/20

(52) U.S. Cl. 430/60; 399/130; 430/125.3; 430/133; 430/56

(57) ABSTRACT

The object of the present invention is to provide an image-receiving sheet for the electrophotography which is excellent in the adhesion resistance and can form an image having a high image quality and an effective manufacturing method thereof, and also a image-forming process and image-forming system for the electrophotography using the image-receiving sheet for the electrophotography. For this object, the present invention provides an image-receiving sheet for the electrophotography comprising a support and a toner image-receiving layer disposed on at least one surface of the support which comprises at least a polymer used for producing the toner image-receiving layer, wherein the image-receiving sheet for the electrophotography comprises particles and the particle size distribution (standard deviation/volume average particle diameter) of the particles projecting out of the most outer surface of the toner image-receiving sheet for the electrophotography is 0.4 or less.

### TECHNICAL FIELD

The present invention relates to an image-receiving sheet for the electrophotography which is excellent in the adhesion resistance and can form an image having a high image quality and an effective manufacturing method thereof, and relates also to an image-forming process and image-forming system for the electrophotography using the image-receiving sheet for the electrophotography.

### BACKGROUND ART

Conventionally, since the electrophotograph can be out-put on a general-purpose paper (such as a general paper and a woodfree paper), it is applied to a copy machine or an out-put devise of the personal computer; however, when an image information, such as a humane face and a landscape, is out-put as a photograph on a general-purpose paper, the produced image has poor gloss or a different image from the actual image, therefore, a specified paper for the electrophotography is desired and for obtaining a specified paper for the electrophotography having excellent gloss, many attempts for the image-receiving sheet for the electrophotography in which on the support, the toner image-receiving layer comprising a thermoplastic resin is disposed were proposed. (see Japanese Patent Application Laid-Open (JP-A) Nos. 04-212168 and 08-211645).

However, when the image-receiving sheets for the electrophotography having high glossiness are piled up and stored, a problem is posed wherein before the image-forming, the support of an image-receiving sheet is adhered to the toner image-receiving layer of another image-receiving sheet which is piled under the former image-receiving sheet, and after the image-forming, the image is adhered to a surface of an image-receiving sheet which is contacted to the image.

For solving such a problem, from the viewpoint of improving adhesion resistance, it has been attempted that the image-receiving layer comprises a matting agent. For example, a transparent image-receiving sheet is proposed, wherein a transparent image-receiving layer of the transparent image-receiving sheet comprises organic resin fine particles and organic resin fine particles project out of the transparent image-receiving layer, so that it is prevented that the transparent image-receiving sheets adhere to each other (see JP-A No. 05-330263).

As an image-receiving sheet for the electrophotography which is excellent not only in adhesion resistance but also in glossiness, an image-receiving sheet for the electrophotography in which the image-receiving layer comprises a matting agent and the sheet has a surface gloss level Gs (45°) (which is measured according to JIS Z 8741 under the condition where the angle of incidence is 45 degree) of 40 or more is proposed. (see JP-A No. 2001-183860)

Further, as an applicable sheet to the photograph, an image-receiving sheet for the electrophotography in which a matting agent is softened at the temperature for the image-fixing (see JP-A No. 2002-258507), an image-receiving sheet for the electrophotography in which the relationship between the average particle diameter of the matting agent and the thickness of the most outer coating-disposed layer of the image-receiving sheet for the electrophotography is specified (see JP-A No. 2003-330213) and an image-receiving sheet for the electrophotography in which the area ratio of the surface part where the matting agent projects out of the surface of the sheet to the whole surface of the sheet is specified (see JP-A 2003-330214) are proposed.

However, in JP-A Nos. 05-330263, 2001-183860 and 2002-258507, there is disclosed only to use the matting agent from the viewpoint of improving adhesion resistance. In JP-A Nos. 2003-330213 and 2003-330214, there is disclosed only the average particle diameter of the matting agent and the area ratio of the surface part where the matting agent projects out of the surface of the sheet respectively. In these patent documents, there is neither disclosed nor indicated with respect to the particle size distribution of the matting agent and from these patent documents, it can be extremely difficulty expected that by controlling the particle size distribution of the matting agent, the image-receiving sheet is excellent in the adhesion resistance and can form an image having a high image quality.

For obtaining the image quality compared to the photograph, it is required that foreign matters do not invade into the surface of the toner image-receiving layer of the image-receiving sheet for the electrophotography and thus, the filtration of the coating liquid for the toner image-receiving layer comprising the matting agent becomes necessary; however, when the particle size distribution of the matting agent is large, a disadvantage is caused wherein the filter is clogged.

### DISCLOSURE OF INVENTION

The object of the present invention is to provide an image-receiving sheet for the electrophotography which is excellent in the adhesion resistance and can form an image having a high image quality and an effective manufacturing method thereof, and also an image-forming process and image-forming system for the electrophotography using the image-receiving sheet for the electrophotography.

In this situation, the present inventors have made extensive and intensive studies with a view toward solving the above-noted problems accompanying the related art. As a result, it has been found that, to use, as a matting agent, mono-dispersed particles (i.e., the particle diameter of particles is uniform) is useful for obtaining an image-receiving sheet for the electrophotography in which the coating liquid for the toner image-receiving layer is excellent in filtering properties, the adhesion resistance of the sheet is improved and an image having a high image, quality can be formed.

Based on this finding, the present invention has been completed. The methods for solving the above-noted problem are as follows.

The image-receiving sheet for the electrophotography according to the present invention is an image-receiving sheet for the electrophotography comprising a support and a toner image-receiving layer disposed on at least one surface of the support which comprises at least a polymer used for producing the toner image-receiving layer, wherein the image-receiving sheet for the electrophotography comprises particles and the particle size distribution (standard deviation/volume average particle diameter) of the particles projecting out of the most outer surface of the toner image-receiving sheet for the electrophotography is 0.4 or less. By using the image-receiving sheet for the electrophotography according to the present invention, an image which is excellent in the adhesion resistance and has a high image quality can be formed.

The manufacturing method of the toner image-receiving sheet for the electrophotography according to the present invention comprises at least coating the support with a coating liquid for producing the toner image-receiving layer. The coating liquid for producing the toner image-receiving layer comprises particles having the particle size distribution (standard deviation/volume average particle diameter) of 0.4 or less and the coating liquid for producing the toner image-receiving layer is filtered. Thus, a toner image-receiving sheet for the electrophotography which is excellent in adhesion resistance and can form an image having a high image quality can be effectively produced.

The image-forming process according to the present invention comprises forming a toner image in the toner image-receiving sheet for the electrophotography according to the present invention and fixing the toner image formed in the forming of the toner image by smoothing the surface of the toner image. According to the image-forming process of the present invention, by a simple treatment, an image having a high image quality compared to that of the silver salt photograph print can be effectively produced.

The image-forming system for the electrophotography according to the present invention comprises a providing unit of the information from the user into an image-forming apparatus and the image-forming apparatus equipped with an apparatus configured to fix the image by smoothing the surface of the toner image comprising a heating-pressuring unit, a belt and a cooling unit, wherein using the image-receiving sheet for the electrophotography, the image is formed. By using the above-noted image receiving sheet for the electrophotography according to the present invention, not only an electrophotograph print having a high gloss level and the same image quality as the silver salt photograph can be easily obtained on the demand of the user at a photo shop, but also the obtained electrophotograph print can suppress the lowering of the gloss level due to an environmental change after the image-forming, so that an electrophotograph print which can maintain the same high image quality as that of the silver salt photograph, can be effectively and easily obtained.

### BRIEF DESCRIPTION OF DRAWINGS

FIG. 1 is a schematic view showing an example of an electrophotography apparatus in a fixing belt system according to the present invention.

FIG. 2 is a schematic view showing an example of an image-forming apparatus according to the present invention.

FIG. 3 is a schematic view showing an example of an apparatus configured to fix the image by smoothing the image surface.

### BEST MODE FOR CARRYING OUT THE INVENTION

(Image-Receiving Sheet for Electrophotography)

The image-receiving sheet for the electrophotography according to the present invention comprises a support, a toner image-receiving layer disposed on at least one surface of the support which comprises at least a polymer for producing the toner image-receiving layer, preferably an intermediate layer disposed between the support and the toner image-receiving layer which comprises a polymer for producing the intermediate layer, and optionally other layers selected properly, such as a surface-protecting layer, a back layer, an adhesion-improving layer, an undercoating layer, a cushion layer, a charge-controlling (preventing) layer, a reflective layer, a tint-controlling layer, a shelf stability-improving layer, an anti-adhesion layer, an anti-curling layer and a smoothing layer, wherein at least one of them comprises particles. These layers may be in a single layer structure or a laminated structure of plural layers. In addition, it is preferred that on the back surface of the support, a back layer comprising the polymer for producing the toner image-receiving layer is disposed. By producing the back layer, the curling preventing properties of the image-receiving sheet for the electrophotography are largely improved.

[Particles]

The particles project out of the most outer surface of the image-receiving sheet for the electrophotography according to the present invention and the particle size distribution (standard deviation/volume average particle diameter) of the projecting particles is 0.4 or less. When the particle size distribution is more than 0.4 (i.e., the diameter of particles becomes ununiform), at a part of the image-receiving sheet where large particles are present during the image-forming, an omission of the toner transfer is caused and therefore, an image having a high image quality cannot be obtained sometimes.

The particles possess the function as a matting agent which any one of the above-noted layers (e.g., the toner image-receiving layer and the intermediate layer) comprises, for example for preventing the off-set of the toner image-receiving layer. Particles used as a matting agent are not restricted and may be properly selected from conventional particles depending on the application. The particles are generally divided into inorganic particles and organic particles.

Examples of the inorganic particles include particles of an oxide (such as silicone dioxide, titanium oxide, magnesium oxide and aluminum oxide), an alkaline earth metal salt (such as barium sulfate, calcium sulfate and magnesium sulfate), a silver halide (such as silver chloride and silver bromide) and a glass.

Examples of the inorganic matting agent comprising the inorganic particles include matting agents described in patent documents, such as West German Patent No. 2529321, G.B. Patent Nos. 760775 and 1260772, and U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245 and 4,029,504.

Examples of the organic particles include particles of a starch, a cellulose ester (e.g., a cellulose acetate propionate), a cellulose ether (e.g., ethyl cellulose) and a synthetic resin. The synthetic resin is preferably a water-insoluble resin or a water-slightly soluble resin. Examples of the water soluble resin or the water-slightly soluble resin include a poly(meth)acrylate, a poly(meth)acrylamide, a polyvinyl ester (such as a polyvinyl acetate), a polyacrylonitrile, a polyolefin (, such as a polyethylene) a polystyrene resin, a benzoguanamine resin, a formaldehyde condensation resin, an epoxy resin, a polyamide resin, a polycarbonate resin, a phenol resin, a polyvinyl carbazole resin and a polyvinylidene chloride resin. Examples of the poly(meth)acrylate include a polyalkyl(meth)acrylate, a polyalkoxyalkyl(meth)acrylate and a polyglycidyl(meth)acrylate.

Examples of the above-noted synthetic resin include also a copolymer produced by copolymerizing monomers used for producing the above-noted homopolymers.

The above-noted copolymer may contain a small amount of a hydrophilic recurring unit. Examples of a monomer which forms the above-noted hydrophilic recurring unit include an acrylic acid, a methacrylic acid, a α,β-dicarboxylic acid, a hydroxyalkyl(meth)acrylate, a sulfoalkyl(meth)acrylate and a styrenesulfonic acid.

Examples of the organic matting agent comprising the organic particles include matting agents described in patent documents, such as G.B. Patent No. 1055713, U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924 and 3,767,448, and JP-A Nos. 49-106821 and 57-14835.

These particles may be used in combination.

The volume average particle diameter of the particles is not restricted so long as the diameter is larger than the thickness of the toner image-receiving layer and may be properly selected depending on the application. The volume average particle diameter is preferably from 3 μm to 30 μm. When the diameter of the particles is less than the thickness of the toner image-receiving layer, the adhesion resistance of the image-receiving sheet is likely to be lowered.

The particle size distribution of the particles can be measured by a method comprising measuring the standard deviation and volume average particle diameter of the particles alone using a particle diameter measuring apparatus (manufactured and sold by Horiba, Ltd.; trade name: LA 920) under the condition where a ultrasonic dispersing time was 2 minutes, and calculating the particle size distribution from the calculated standard deviation and volume average particle diameter according to the following equation:
Particle size distribution=(Standard deviation)/(Volume average particle diameter).

The amount of the particles is not restricted and may be properly selected depending on the application. The amount of the particles is preferably from 0.01 g/m² to 0.5 g/m², more preferably from 0.02 g/m² to 0.3 g/m².

[Support]

The support is not restricted and may be properly selected depending on the application. Examples of the support include a raw paper, a synthetic paper, a synthetic resin sheet, a coated paper and a laminated paper. These supports may be used individually or in combination as a laminated form of plural layers. Among them, the laminated paper produced by disposing polyolefin resin layers on the both sides of the raw paper is preferred from the viewpoint of the smoothness and glossiness and the stretchability.

—Raw Paper—

The raw paper is not restricted and may be properly selected depending on the application. Preferred specific examples of the raw paper include a woodfree paper, such as a paper described in the literature “Basis of Photographic Technology-silver halide photograph (edited by The Society of Photographic Science and Technology of Japan and published by Corona Publishing Co., Ltd. (pp. 223-224 (1979))”

For imparting a desired mean center line roughness to the surface of the raw paper, it is preferred that the raw paper is produced, as described in JP-A No. 58-68037, using a pulp fiber having a fiber length distribution in which a total of a 24 mesh screen remnant and a 42 mesh screen remnant is from 20 to 45% by mass and a 24 mesh screen remnant is 5% by mass or less, based on the mass of all pulp fibers. Moreover, the mean center line roughness of the raw paper can be controlled by subjecting the raw paper to a surface treatment of applying the heat and pressure by means of a machine calendar or a super calendar.

The raw paper is not restricted so long as the raw paper is a conventional material used for the support and may be properly selected from various types of materials depending on the application. Examples of the materials of the raw paper include a natural pulp made from a needle-leaf tree or a broadleaf tree and a mixture of the natural pulp and the synthetic pulp.

As a pulp which can be used as a material of the raw paper, from the viewpoint of improving simultaneously surface smoothness, stiffness and dimensional stability (curling properties) of the raw paper in a good balance and to a satisfactory level, broadleaf tree bleached craft pulp (LBKP) is preferred. Needle-leaf bleached craft pulp (NBKP) and broadleaf tree sulfite pulp (LBSP) can be also used.

For beating the pulp, a beater or a refiner can be used.

From the viewpoint of suppressing the shrinkage of the paper in making the paper, the Canadian Standard Freeness (CSF) of the pulp is preferably from 200 to 440 ml CSF, more preferably from 250 to 380 ml CSF.

The pulp slurry (hereinafter, occasionally referred to as “pulp paper material”) which is obtained after beating the pulp comprises optionally various additives, such as a filler, a dry paper reinforcer, a sizing agent, a wet paper reinforcer, an adhesion promoter, a pH controller and other agents.

Examples of the filler include calcium carbonate, clay, kaolin, white clay, talc, titanium oxide, diatomaceous earth, barium sulfate, aluminum hydroxide and magnesium hydroxide.

Examples of the dry paper reinforcer include cationic starch, cationic polyacrylamide, anionic polyacrylamide, amphoteric polyacrylamide, carboxy-modified polyvinyl alcohol.

Examples of the sizing agent include an aliphatic acid salt; rosin derivatives, such as rosin and maleic rosin; paraffin wax; and a compound containing a higher aliphatic acid, such as an alkyl ketene dimmer, an alkenyl succinic anhydride (ASA) and an epoxidized aliphatic amide.

Examples of the wet paper reinforcer include a polyamine polyamide epichlorohydrin, a melamine resin, a urea resin and an epoxidized polyamide resin.

Examples of the adhesion promoter include a multivalent metal salt, such as aluminum sulfate and aluminum chloride; and a cationic polymer, such as a cationic starch.

Examples of the pH controller include caustic soda and sodium carbonate.

Examples of the other agents include an anti-foaming agent, a dye, a slime control agent and a fluorescent whitening agent.

Further optionally, the pulp slurry may comprise a flexibilizer. Examples of the flexibilizer include an agent described in the literature “Paper and Paper Treatment Manual (published by Shiyaku Time Co., Ltd. (pp. 554-555 (1980)).

These various additives may be used individually or in combination. The amount of the various additives in the pulp paper material is not restricted and may be selected depending on the application. The amount is preferably 0.1 to 1.0% by mass, based on the mass of the pulp paper material.

The pulp paper material (which is optionally prepared by incorporating the various additives into the pulp slurry) is subjected to the papermaking using a paper machine, such as a manual paper machine, a Fourdrinier (long-net) paper machine, a round-net paper machine, a twin-wire machine and a combination machine, and the made paper is dried to produce the raw paper. If desired, either before or after the drying of the made paper, the made paper may be subjected to the surface sizing treatment.

The treating liquid used for the surface sizing treatment is not restricted and may be properly selected depending on the application. Examples of the compound contained in the treating liquid include a water-soluble polymer, a waterproof compound, a pigment, a dye and a fluorescent whitening agent.

Examples of the water-soluble polymer include a cationic starch, a polyvinyl alcohol, a carboxy-modified polyvinyl alcohol, a carboxymethylcellulose, a hydroxyethylcellulose, a cellulose sulfate, gelatin, casein, a sodium polyacrylate, a sodium salt of styrene-maleic anhydride copolymer and a sodium salt of polystyrenesulfonic acid.

Examples of the waterproof compound include latexes and emulsions, such as a styrene-butadiene copolymer, an ethylene-vinyl acetate copolymer, a polyethylene and a vinylidene chloride copolymer; and a polyamide polyamine epichlorohydrin.

Examples of the pigment include calcium carbonate, clay, kaolin, talc, barium sulfate and titanium oxide.

From the viewpoint of improving stiffness and dimensional stability (curling properties) of the raw paper, it is preferred that the raw paper has the ratio (Ea/Eb) of the longitudinal Young's modulus (Ea) and the lateral Young's modulus (Eb) of from 1.5 to 2.0. When the ratio (Ea/Eb) is less than 1.5 or more than 2.0, the stiffness and the curling properties of the image-receiving sheet for the electrophotography may be easily impaired, so that a disadvantage is caused wherein the conveyability of the image-receiving sheet for the electrophotography is hindered.

Generally, it has been clarified that the “nerve” of the paper is varied depending on the method for beating the pulp and as an important index indicating the “nerve” of the paper, the modulus of elasticity of the paper made by the papermaking after the beating of the pulp, can be used. The modulus of elasticity of the paper can be calculated according to the following equation:
E=ρc²(1−n²)
where “E” represents dynamic modulus, “ρ” represents the density of the paper, “c” represents the velocity of sound in the paper, and “n” represents the Poisson's ratio,
   by using the relation between the dynamic modulus of the paper indicating the properties as a viscoelastic body and the density of the paper, and the velocity of sound in the paper measured using an ultrasonic oscillator.

In addition, since n=0.2 or so with respect to an ordinary paper, there is not much difference between the calculation of the dynamic modulus according to the above-noted equation and the calculation according to the following equation:
E=ρc².

Accordingly, when the density of the paper and the velocity of sound in the paper can be measured, the elastic modulus of the paper can be easily calculated. For measuring the velocity of sound in the paper, various conventional instruments, such as a Sonic Tester SST-110 (Manufactured and sold by Nomura Shoji Co., Ltd.) can be used.

The thickness of the raw paper is not restricted and may be properly selected depending on the application. The thickness is usually preferably from 30 μm to 500 μm, more preferably from 50 μm to 300 μm, still more preferably from 100 μm to 250 μm. The basis weight of the raw paper is not restricted and may be properly selected depending on the application. The basis weight is preferably from 50 g/m² to 250 g/m², more preferably from 100 g/m² to 200 g/m².

—Synthetic Paper—

The synthetic paper is a paper comprising mainly another polymer fiber than a cellulose and examples of the another polymer fiber include a polyolefin fiber, such as a polyethylene fiber and a polypropylene fiber.

—Synthetic Resin Sheet (Film)—

Examples of the synthetic resin sheet include a synthetic resin shaped into the form of sheet, such as a polypropylene film, an oriented polyethylene film, an oriented polypropylene film, a polyester film, an oriented polyester film and a nylon film. In addition, a film whitened by orienting the film and a white film comprising a white pigment can be also used.

—Coated Paper—

The coated paper is a paper produced by coating either a single surface or the both surfaces of the support, such as the raw paper with various resins and the amount of a resin as a coating material is varied depending on the application of the coated paper. Examples of the coated paper include an art paper, a cast-coated paper and a Yankee paper.

The resin with which the surface of the raw paper is coated is not restricted and may be properly selected depending on the application. The resin is preferably a thermoplastic resin. Examples of the thermoplastic resin include (1) polyolefin resins and derivatives thereof, (2) polystyrene resins, (3) acrylic resins, (4) a polyvinyl acetate and derivatives thereof, (5) polyamide resins, (6) a polyester resin, (7) a polycarbonate resin, (8) a polyether resin (or an acetal resin), and (9) other resins. These thermoplastic resins may be used individually or in combination.

Examples of the polyolefin resins (1) include a polyolefin resin, such as a polyethylene and a polypropylene; and a copolymer resin produced by copolymerizing an olefin, such as ethylene and propylene with another vinyl monomer. Examples of such a copolymer resin (produced by copolymerizing an olefin with another vinyl monomer) include an ethylene-vinyl acetate copolymer and an ionomer resin which is produced by copolymerizing an olefin with acrylic acid or methacrylic acid. Examples of the derivatives of the polyolefin resins include a chlorinated polyethylene and a chlorosulfonated polyethylene.

Examples of the polystyrene resins (2) include a polystyrene resin, a styrene-isobutylene copolymer, an acrylonitrile-styrene copolymer (AS resin), an acrylonitrile-butadiene-styrene copolymer (ABS resin) and a polystyrene-maleic anhydride resin.

Examples of the acrylic resins (3) include a polyacrylic acid and esters thereof, a polymethacrylic acid and esters thereof, a polyacrylonitrile and a polyacrylamide. The properties of an ester of the poly(meth)acrylic acid are largely varied depending on the type of an ester group contained in the ester of the poly(meth)acrylic acid. Also, examples of the acrylic resins (3) include a copolymer produced by copolymerizing, for example, acrylic (methacrylic) acid with another monomer (e.g., methacrylic (acrylic) acid, a styrene and a vinyl acetate). The polyacrylonitrile is used more frequently as a material of the As resin or the ABS resin than as a homopolymer (i.e., as it is).

Examples of a polyvinyl acetate and derivatives thereof (4) include a polyvinyl acetate, a polyvinyl alcohol produced by saponifying the polyvinyl acetate and a polyvinylacetal resin produced by reacting the polyvinyl alcohol with an aldehyde (e.g., formaldehyde, acetaldehyde and butyraldehyde).

The polyamide resins (5) are polycondensates of a diamine and a dibasic acid and examples thereof include 6-nylon and 6,6-nylon.

The polyester resin (6) is a polycondensate of an acid and an alcohol and the properties of the polyester resin are largely varied depending on the type of the combination of an acid and an alcohol. Specific examples of the polyester resin (6) include a versatile resin produced from an aromatic dibasic acid and a bifunctional alcohol, such as a polyethyleneterephthalate and a polybutylenephthalate.

General examples of the polycarbonate resin (7) include a polycarbonate ester produced from bisphenol A and phosgene.

Examples of the polyether resin (or the acetal resin) (8) include a polyether resin, such as a polyethylene oxide and a polypropylene oxide (or an acetal resin produced by a ring opening polymerization, such as a polyoxymethylene).

The other resins (9) include a polyurethane resin produced by an addition polymerization.

The thermoplastic resin may optionally comprise a brightener, a conductive filler, a filler, titanium oxide, and a pigment or dye, such as a ultramarine and a carbon black.

—Laminated Paper—

The laminated paper is a paper produced by laminating a material for the laminating, such as various resins, a rubber, a polymer sheet or a polymer film on the surface of the support, such as the raw paper. Examples of the material for the laminating include a polyolefin resin, a polyvinyl chloride resin, a polyester resin, a polystyrene resin, a polymethacrylate resin, a polycarbonate resin, a polyimide resin and a triacetyl cellulose. These resins may be used individually or in combination.

The polyolefin resin is, in general, frequently produced using a low-density polyethylene. For improving heat resistance of the support, however, it is preferred to produce the polyolefin resin using a polypropylene resin, a mixture of a polypropylene resin and a polyethylene resin, a high-density polyethylene resin or a mixture of a high-density polyethylene resin and a low-density polyethylene resin. Particularly from the viewpoint of the cost and laminatability, it is most preferred to produce the polyolefin resin using the mixture of a high-density polyethylene resin and a low-density polyethylene resin.

The mixing ratio (in terms of the mass ratio) between the high-density polyethylene and the low-density polyethylene is preferably from 1:9 to 9:1, more preferably from 2:8 to 8:2, still more preferably from 3:7 to 7:3.

For disposing a thermoplastic resin layer on both surfaces of the raw paper, it is preferred that on the rear surface of the raw paper, a thermoplastic resin layer is disposed using a high-density polyethylene resin or a mixture of a high-density polyethylene resin and a low-density polyethylene resin. The molecular weight of the polyethylene resin is not restricted and may be properly selected depending on the application; however, it is preferred that the polyethylene resin is produced using a high-density polyethylene resin and a low-density polyethylene resin both of which have the melt index of from 1.0 g/10 min to 40 g/10 min and both of which have extrudability.

The polymer sheet or the polymer film as the above-noted materials for the laminating may be subjected to a treatment of imparting white reflectivity. Examples of such a treatment include a method for incorporating a pigment, such as titanium oxide in the composition of the polymer sheet or the polymer film.

The support has a thickness of preferably from 25 μm to 300 μm, more preferably from 50 μm to 260 μm, still more preferably from 75 μm to 220 μm. The stiffness of the support may be selected depending on the application. The support for producing the image-receiving sheet for the electrophotography has preferably a similar stiffness to the stiffness which the support for producing the image-receiving sheet for the color silver salt-photography has.

<Toner Image-Receiving Layer>

The toner image-receiving layer receives a color toner and a black toner, and forms the image. The toner image-receiving layer has a function of receiving the toner for forming the image from a developing drum or an intermediate transfer medium by (static) electricity or pressure in the transferring and a function of fixing the image by heat or pressure in the fixing.

The amount of a pigment in the toner image-receiving layer is preferably less than 40% by mass, more preferably less than 30% by mass, still more preferably less than 20% by mass, most preferably 0% by mass, based on the mass of the polymer which the toner image-receiving layer comprises. When the amount of the pigment is large, a disadvantage is caused wherein the toner image-receiving layer may easily cause the blister, so that an obtained toner image is roughened.

The toner image-receiving layer may be disposed on at least one surface of the support through an intermediate layer. In this case, the toner image-receiving layer may be disposed on the intermediate layer by melting a polymer used for the toner image-receiving layer on the intermediate layer and the toner image-receiving layer is preferably disposed on the intermediate layer by coating the intermediate layer with a coating liquid for the toner image-receiving layer. By using the coating liquid for the toner image-receiving layer, the image-receiving sheet for the electrophotography can be relatively easily produced.

The toner image-receiving layer comprises at least the above-noted particles and the above-noted polymer used for the toner image-receiving layer, and optionally various additives for improving thermodynamic properties of the toner image-receiving layer. Examples of the additives include a natural wax, a releasing agent, a plasticizer, a colorant, a filler, a cross-linking agent, a charge control agent, an emulsifier and a dispersant.

<Polymer Used for Toner Image-Receiving Layer>

The polymer used for the toner image-receiving layer has a glass transition temperature (Tg) of preferably 35° C. or more, more preferably from 50° C. to 100° C. When the glass transition temperature (Tg) is less than 35° C., a toner image-receiving layer which has been disposed by the coating may have poor adhesiveness.

When the toner image-receiving layer is disposed on the intermediate layer, the polymer used for the toner image-receiving layer has preferably a higher glass transition temperature than that of the polymer used for the intermediate layer. When the polymer used for the toner image-receiving layer has a glass transition temperature which is the same glass transition temperature as or a lower glass transition temperature than that of the polymer used for the intermediate layer, the gloss level of the print surface may be lowered.

The glass transition temperature (Tg) of the polymer used for the toner image-receiving layer is higher than the glass transition temperature (Tg) of the polymer used for the intermediate layer preferably by 10° C. or more, more preferably by 20° C. or more.

The polymer used for the toner image-receiving layer has the glass transition temperature (Tg) of 35° C. or more; however, the polymer used for the toner image-receiving layer is not restricted so long as the polymer can be deformed at the temperature for the image-fixing and can receive the toner and may be properly selected depending on the application. For example, the polymer used for the toner image-receiving layer is preferably a resin having the same type as a type of a resin used as a binder resin for the toner. Since as a binder resin for the toner, usually a polyester resin, a styrene-acrylate ester copolymer and a styrene-methacrylate ester copolymer are used, the polymer used for the toner image-receiving layer according to the present invention is produced using preferably a thermoplastic resin, such as a polyester resin, a styrene-acrylate ester copolymer and a styrene-methacrylate ester copolymer.

The polymer used for the toner image-receiving layer is not restricted and may be properly selected from conventional polymers depending on the application. The polymer used for the toner image-receiving layer is preferably a thermoplastic resin. Examples of the thermoplastic resin include a thermoplastic resin selected from the group consisting of the thermoplastic resins (1) to (9) which are exemplified above as a preferred thermoplastic resin with which the surface of the raw paper is coated for producing the above-noted coated paper. These thermoplastic resins may be used individually or in combination. Among them, particularly from the viewpoint of embedding the toner, styrene resins, acrylic resins, styrene-acrylic acid resins and polyester resins which have a large cohesive energy are preferably used.

Examples of the above-noted styrene resins include a polystyrene homopolymer, a styrene-isobutylene copolymer, a styrene-butadiene copolymer, an acrylonitrile-styrene copolymer (AS resin), an acrylonitrile-butadiene-styrene copolymer (ABS resin) and a polystyrene-maleic anhydride resin.

Examples of the above-noted acrylic resins include a polyacrylic acid and esters thereof, a polymethacrylic acid and esters thereof, a polyacrylonitrile and a polyacrylamide.

Examples of the esters of the polyacrylic acid include a homopolymer and multi-system copolymer of an acrylate ester. Examples of the acrylate ester include methyl acrylate, ethyl acrylate, n-butyl acrylate, isobutyl acrylate, dodecyl acrylate, n-octyl acrylate, 2-ethylhexyl acrylate, 2-chloroethyl acrylate, phenyl acrylate and α-methyl chloroacrylate.

Examples of the esters of the polymethacrylic acid include a homopolymer and multi-system copolymer of an methacrylate ester. Examples of the methacrylate ester include methyl methacrylate, ethyl methacrylate and butyl acrylate.

Examples of the above-noted styrene-acrylic acid resins include a copolymer of styrene with the above-noted acrylate ester or methacrylate ester.

The above-noted polyester resins are produced by a polycondensation of an acid component and an alcohol component. The acid component is not restricted and may be properly selected depending on the application. Examples of the acid component include maleic acid, fumaric acid, citraconic acid, itaconic acid, glutaconic acid, phthalic acid, terephthalic acid, isophthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, trimellitic acid, pyromellitic acid, and anhydrides of these acids and esters of these acids with lower alkyls.

The alcohol component is not restricted and may be properly selected depending on the application. Preferred examples of the alcohol component include a dihydric alcohol, such as an aliphatic diol and an alkylene oxide adduct of a bisphenol A. Examples of the aliphatic diol include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol. Examples of the alkylene oxide adduct of the bisphenol A include polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane and polyoxypropylene (6)-2,2-bis(4-hydroxyphenyl)propane.

The polymer used for the toner image-receiving layer can satisfy the requirements for the physical properties (which are described below) of the toner image-receiving layer, preferably in the form of a toner image-receiving layer which is produced from the polymer, more preferably in the form of the polymer alone. It is also preferred that for producing the toner image-receiving layer, two or more types of resins exhibiting different physical properties (which are described below) of the toner image-receiving layer are used in combination.

The polymer used for the toner image-receiving layer preferably has a larger molecular weight than that of a thermoplastic resin used for the toner. However, this relationship in the molecular weight between the polymer and the thermoplastic resin is not always preferred depending on the relationship in the thermodynamic properties between the polymer and the thermoplastic resin. For example, when the polymer used for the toner image-receiving layer has a higher softening point than that of the thermoplastic resin used for the toner, it is sometimes preferred that the polymer used for the toner image-receiving layer has a molecular weight equivalent to or lower than that of the thermoplastic resin used for the toner.

It is also preferred that as the polymer used for the toner image-receiving layer, a mixture of resins having the same composition and different average molecular weight from each other is used. The relationship in the molecular weight between the polymer used for the toner image-receiving layer and the thermoplastic resin used for the toner is preferably the relationship disclosed in JP-A No. 08-334915.

It is preferred that the polymer used for the toner image-receiving layer has a larger molecular-weight distribution than that of the thermoplastic resin used for the toner.

It is preferred that the polymer used for the toner image-receiving layer satisfies the requirements for physical properties disclosed in JP-A Nos. 05-127413, 08-194394, 08-334915, 08-334916, 09-171265, and 10-221877.

As the polymer used for the toner image-receiving layer, a hydrophilic polymer, such as a water-dispersible polymer and a water-soluble polymer is preferably used for the following reasons.

(i) In the coating and the drying, no organic solvent should be discharged, so that these polymers are excellent in environmental suitability and workability.

(ii) Many types of the releasing agent, such as waxes, which is incorporated in the resin composition for producing the toner image-receiving layer can be difficulty dissolved in a solvent at room temperature and are often dispersed in a solvent (e.g., water or an organic solvent) before the use. These releasing agents are stable in the form of an aqueous dispersion and these releasing agents in the form of an aqueous dispersion are excellent in suitability for the processing. Further, when an aqueous coating liquid comprising a mixture of the polymer used for the toner image-receiving layer and a releasing agent in the form of an aqueous dispersion is applied for producing the toner image-receiving layer, in the drying, the releasing agent (e.g., a wax) bleeds out easily on the surface of the coated layer, so that the effect of the releasing agent (e.g., anti-offset properties and adhesion resistance) can be easily obtained.

The above-noted hydrophilic polymer is not restricted with respect to the composition, the bonding structure, the molecular structure, the molecular weight, the molecular-weight distribution and the form so long as the hydrophilic polymer is a water-dispersible polymer or a water-soluble polymer and may be properly selected depending on the application. Examples of the hydrophilic group of the above-noted hydrophilic polymer include a sulfonic group, a hydroxyl group, a carboxyl group, an amino group, an amido group and an ether group.

The water-dispersible polymer may be selected from the group consisting of water-dispersed resins and emulsions produced by dispersing at least one of the thermoplastic resins (1) to (9) described above in the section of Coated Paper, copolymers of these thermoplastic resins, mixtures of these thermoplastic resins and cation-modified products of these thermoplastic resins, and these water-dispersible polymers may be used in combination.

The water-dispersible polymer may be a properly synthesized product or a commercially available product. Specific examples of the commercially available water-dispersible polyester polymer include the Vylonal Series (manufactured and sold by Toyobo Co., Ltd), the Pesresin A Series (manufactured and sold by Takamatsu Oil & Fat Co., Ltd.), the Tuftone UE Series (manufactured and sold by Kao Corporation), the WR Series (manufactured and sold by Nippon Synthetic Chemical Industry Co., Ltd.) and the Elitel Series (manufactured and sold by Unitika Ltd). Specific examples of the commercially available water-dispersible acrylic polymer include the Hiros XE, KE and PE series (manufactured and sold by Seiko Chemical Industries Co., Ltd.) and the Jurymer ET series (manufactured and sold by Nihon Junyaku Co., Ltd.).

The water-dispersible emulsion is not restricted and may be properly selected depending on the application. Examples of the water-dispersible emulsion include a water-dispersible polyurethane emulsion, a water-dispersible polyester emulsion, a chloroprene polymer emulsion, a styrene-butadiene copolymer emulsion, a nitrile-butadiene copolymer emulsion, a butadiene polymer emulsion, a vinyl chloride polymer emulsion, a vinylpyridine-styrene-butadiene copolymer emulsion, a polybutene emulsion, a polyethylene emulsion, a vinyl acetate polymer emulsion, an ethylene-vinyl acetate copolymer emulsion, a vinylidene chloride polymer emulsion and a methyl methacrylate-butadiene copolymer emulsion. Among them, the water-dispersible polyester emulsion is most preferred.

The water-dispersible polyester emulsion is preferably a self-dispersible water-dispersible polyester emulsion, most preferably a self-dispersible water-dispersible polyester emulsion containing a carboxyl group. Here, the self-dispersible water-dispersible polyester emulsion means an aqueous emulsion containing a polyester resin which can be self-dispersed in an aqueous solvent without using an emulsifier. The self-dispersible water-dispersible polyester emulsion containing a carboxyl group means an aqueous emulsion containing a polyester resin having a carboxyl group as a hydrophilic group, which can be self-dispersed in an aqueous solvent.

The self-dispersible water-dispersible emulsion can preferably satisfy the following properties (1) to (4). The emulsion is a self-dispersible polyester emulsion which is produced using no surfactant, so that the emulsion has low hygroscopicity even in an atmosphere having high humidity and exhibits a small decrease of the softening point due to the moisture, so that the image-receiving sheet produced using the emulsion as a polymer used for the toner image-receiving layer can suppress the offset during the image-fixing and the adhesion between the image-receiving sheets during the storage. The above-noted polyester emulsion is produced using a water-dispersible polyester, so that the emulsion is excellent in environmental suitability and workability. In addition, since the emulsion is produced using a polyester resin which takes easily a molecular structure having a high cohesive energy, while during the storage, the emulsion maintains satisfactory hardness, during the image-fixing of the electrophotography, the emulsion falls into a molten state having low elasticity (i.e., low viscosity), so that the toner is embedded in the toner image-receiving layer and accordingly, the image-receiving sheet can obtain a satisfactorily high image quality.

(1) The number-average molecular weight (Mn) of the emulsion is preferably from 5,000 to 10,000, more preferably from 5,000 to 7,000.

(2) The molecular-weight distribution (weight average molecular weight/number average molecular weight) is preferably 4 or less, more preferably 3 or less.

(3) The glass transition temperature Tg of the emulsion is preferably from 40° C. to 100° C., more preferably from 50° C. to 80° C.

(4) The volume average particle diameter is preferably from 20 nm to 200 nm, more preferably from 40 nm to 150 nm.

The amount of the water-dispersible emulsion is preferably from 10% by mass to 90% by mass, more preferably from 10% by mass to 70% by mass, based on the mass of the toner image-receiving layer.

The above-noted water-soluble polymer is not restricted and may be selected depending on the application. The water-soluble polymer may be also a properly synthesized product or a commercially available product. Examples of the water-soluble polymer include a polyvinyl alcohol, a carboxy-modified polyvinyl alcohol, a carboxymethyl cellulose, a hydroxyethyl cellulose, a cellulose sulfate, a polyethylene oxide, a gelatin, a cationized starch, a casein, a sodium polyacrylate, a sodium salt of a styrene-maleic anhydride copolymer and a sodium polystyrene sulfonate. Among them, the polyethylene oxide is preferred.

Examples of the commercially available water-soluble polyester (as one of the above-noted water-soluble polymer) include various Plas Coats (manufactured and sold by Goo Chemical Co., Ltd.) and the Finetex ES series (manufactured and sold by Dainippon Ink & Chemicals Inc.) Examples of the water-soluble polyacrylate include the Jurymer AT series (manufactured and sold by Nihon Junyaku Co., Ltd.), Finetex 6161 and K-96 (manufactured and sold by Dainippon Ink & Chemicals Inc.) and Hiros NL-1189 and BH-997L (manufactured and sold by Seiko Chemical Industries Co., Ltd.)

Examples of the water-soluble polymer include also polymers which are described in Research Disclosure No. 17,643, pp. 26; Research Disclosure No. 18,716, pp. 651; Research Disclosure No. 307,105, pp. 873-874; and JP-A No. 64-13546.

The amount of the water-soluble polymer in the toner image-receiving layer is not restricted and may be properly selected depending on the application. The amount is preferably from 0.5 g/m² to 2 g/m².

The toner image-receiving layer comprises preferably the water-dispersible emulsion and the water-soluble polymer, and optionally other components.

The volume average particle diameter of the water-dispersible emulsion has the lower limit value of preferably 20 nm, more preferably 55 nm. The upper limit value thereof is not restricted and preferably 200 nm. When the water-dispersible emulsion has a volume average particle diameter of less than 20 nm, the agglomeration of a coating liquid for producing the toner image-receiving layer is easily caused, so that film formation properties of the coating liquid is likely to be impaired.

The volume average particle diameter can be measured, for example, according to a method in which a water-dispersible polyester emulsion is diluted with an ion-exchanged water, thereby preparing a sample for the measurement and the prepared sample is subjected to the measurement using a measuring apparatus COULTER MODEL N 4 SD (manufactured and sold by COULTER ELECTRONICS LTD.).

The water-soluble polymer has a weight average molecular weight of generally 400,000 or less, preferably of from 100,000 to 400,000. When the weight average molecular weight (Mw) is more than 400,000, the agglomeration of the coating liquid is easily caused and surface properties of the coating is likely to be impaired.

The adsorption of the water-soluble polymer in the coating liquid for producing the toner image-receiving layer comprising the water-dispersible emulsion and the water-soluble polymer is preferably less than 2% by mass, based on the mass of the water-soluble polymer. When the adsorption of the water-soluble polymer is more than 2% by mass, the agglomeration is sometimes caused in the coating liquid for producing the toner image-receiving layer comprising the water-dispersible emulsion and the water-soluble polymer.

The adsorption of the water-soluble polymer (e.g., polyethylene oxide) can be measured according to a method comprising mixing the water-dispersible emulsion and the water-soluble polymer (in a mass ratio; the mass of the emulsion: the mass of the polymer=100:17), subjecting the resultant mixture to the centrifugal separation, determining the mass of the water-soluble polymer (e.g., polyethylene oxide) dissolved in the supernatant liquid of the above-centrifugally separated mixture using the NMR and calculating the adsorption (in terms of the mass) of the water-soluble polymer (e.g., polyethylene oxide) from the above-determined mass of the dissolved water-soluble polymer and the mass of the water-soluble polymer (e.g., polyethylene oxide) which is mixed above with the emulsion.

When the adsorption is in the range of from 2% by mass to 5% by mass, the exhaustion agglomeration is caused in the coating liquid and when the adsorption is 30% by mass or more, the agglomeration due to the adsorption or crosslinkage of the water-soluble polymer is caused in the coating liquid.

The mass ratio (the emulsion: the polymer) between the water-dispersible emulsion and the water-soluble polymer is preferably from 1:0.01 to 1:1, more preferably from 1:0.1 to 1:1.

It is preferred that the polymer used for producing the toner image-receiving layer has properties described in the following sections (1) to (5) in comparison with a polymer used for producing the intermediate layer.

(1) The polymer used for the toner image-receiving layer has a softening temperature (Ts) which is higher than that of the polymer used for the intermediate layer by preferably 10° C. or more, most preferably 20° C. or more. By controlling the softening temperatures of the polymers, the glossiness of the toner image-receiving sheet can be controlled. The measurement of the softening temperature can be performed according to the method specified in, for example, JIS K7210.

(2) The polymer used for the toner image-receiving layer has a softening point T_{1/2} (softening point measured according to the ½ method) which is higher than that of the polymer used for the intermediate layer by preferably 10° C. or more, most preferably 20° C. or more. By controlling the softening points measured according to the ½ method of the polymers, the glossiness of the toner image-receiving sheet can be controlled.

(3) The polymer used for the toner image-receiving layer has a flash-beginning temperature (Tfb) which is higher than that of the polymer used for the intermediate layer by preferably 10° C. or more, most preferably 20° C. or more. By controlling the flash-beginning temperatures of the polymers, the glossiness of the toner image-receiving sheet can be controlled.

(4) The polymer used for the toner image-receiving layer has a viscosity at the temperature for the image-fixing which is preferably 3 times or more, most preferably 10 times or more larger than that of the polymer used for the intermediate layer. By controlling the viscosities of the polymers at the temperature for the image-fixing, the glossiness of the toner image-receiving sheet can be controlled.

(5) The polymer used for the toner image-receiving layer has a storage elasticity modulus (G′) at the temperature for the image-fixing which is preferably 3 times or more, most preferably 10 times or more larger than that of the polymer used for the intermediate layer. By controlling the storage elasticity moduli (G′) at the temperature for the image-fixing of the polymers, the glossiness of the toner image-receiving sheet can be controlled.

(6) The polymer used for the toner image-receiving layer has a loss elasticity modulus (G″) at the temperature for the image-fixing which is preferably 3 times or more, most preferably 10 times or more larger than that of the polymer used for the intermediate layer. By controlling the loss elasticity moduli (G″) at the temperature for the image-fixing of the polymers, the glossiness of the toner image-receiving sheet can be controlled.

Further, the polymer used for the toner image-receiving layer has a number average molecular weight which is smaller than that of the polymer used for the intermediate layer by preferably 1,000 to 100,000, most preferably 1,000 to 10,000. By controlling the number average molecular weights of the polymers, the glossiness of the toner image-receiving sheet can be controlled.

The polymer used for the toner image-receiving layer has a molecular-weight distribution which is smaller than that of the polymer used for the intermediate layer by preferably 0.2 to 5. By controlling the molecular-weight distributions of the polymers, the glossiness of the toner image-receiving sheet can be controlled.

The polymer used for producing the toner image-receiving layer may be used in combination with other polymer materials. In this case, the amount of the polymer used for the toner image-receiving layer is generally larger than that of other polymer materials.

More specifically, the amount of the polymer used for the toner image-receiving layer is preferably 10% by mass or more, more preferably 30% by mass or more, still more preferably 50% by mass or more, most preferably from 50% by mass to 90% by mass, based on the mass of the toner image-receiving layer.

In the present invention, from the viewpoint of providing an image-receiving sheet for the electrophotography which is excellent particularly in anti-offset properties, adhesion resistance, conveyability and glossiness, and in which the crazing is hardly caused and an image having a high quality can be formed, the toner image-receiving layer comprises preferably a natural wax.

—Natural Wax—

Preferred examples of the natural wax include a vegetable wax, an animal wax, a mineral wax and a petroleum wax. Among them, the vegetable wax is most preferred. As the natural wax, particularly from the viewpoint of the compatibility of the wax with a hydrophilic resin used as the polymer for producing the toner image-receiving layer, a water-dispersible natural wax is preferred.

The vegetable wax is not restricted and may be properly selected from conventional vegetable waxes which may be properly synthesized or commercially available. Examples of the vegetable wax include a carnauba wax, a castor oil, a rape oil, a soy bean oil, a Japan tallow, a cotton wax, a rice wax, a sugarcane wax, a candelilla wax, a Japan wax and a jojoba oil.

Examples of the carnauba wax which is commercially available include EMUSTAR-0413 (manufactured and sold by Nippon Seiro Co., Ltd.) and SELOSOL 524 (manufactured and sold by Chukyo Yushi Co., Ltd.). Examples of the castor oil which is commercially available include a purified castor oil (manufactured and sold by Itoh Oil Chemicals Co., Ltd).

Among them, particularly from the viewpoint of providing an image-receiving sheet for the electrophotography which is excellent particularly in anti-offset properties, adhesion resistance, conveyability and glossiness, and in which the crazing is hardly caused and an image having a high quality can be formed, the carnauba wax having a melting point of from 70 to 95° C. is most preferred.

The animal wax is not restricted and may be properly selected from conventional animal waxes. Examples of the animal wax include a bees wax, a lanolin, a spermaceti wax, a whale oil and a wool wax.

The mineral wax is not restricted and may be properly selected form conventional mineral waxes which may be commercially available or properly synthesized. Examples of the mineral wax include a montan wax, a montan ester wax, an ozokerite and a ceresin.

Among them, particularly from the viewpoint of providing an image-receiving sheet for the electrophotography which is excellent particularly in anti-offset properties, adhesion resistance, conveyability and glossiness, and in which the crazing is hardly caused and an image having a high quality can be formed, the montan wax having a melting point of from 70 to 95° C. is most preferred.

The petroleum wax is not restricted and may be properly selected conventional petroleum waxes which may be commercially available or properly synthesized. Examples of the petroleum wax include a paraffin wax, a microcrystalline wax and a petrolatum.

The amount of the natural wax in the toner image-receiving layer is preferably from 0.1 to 4 g/m², more preferably from 0.2 to 2 g/m².

When the amount is less than 0.1 g/m², the anti-offset properties and the adhesion resistance of the image-receiving sheet may be particularly impaired. On the other hand, when the amount is more than 4 g/m², the quality of the image formed on the image-receiving sheet may be impaired due to excessive wax.

The melting point of the natural wax is, particularly from the viewpoint of the anti-offset properties and the conveyability of the image-receiving sheet, preferably from 70° C. to 95° C., more preferably from 75° C. to 90° C.

—Releasing Agent—

The releasing agent is incorporated in the composition of the toner image-receiving layer for preventing the offset of the toner image-receiving layer. The releasing agent of the present invention is not restricted and may be properly selected depending on the application so long as it is melted or fused by heating at the temperature for the image-fixing and is disposed on the surface of the toner image-receiving layer as a layer of the releasing agent by cooling and solidifying.

Examples of the releasing agent include a silicone compound, a fluorine compound, a wax and a matting agent (i.e., the above-noted particles according to the present invention).

Examples of the releasing agent include also the compounds described in the literatures “Properties and Applications of Waxes, Revised Edition” (published by Saiwai Shobo) and “The Silicon Handbook” (published by THE NIKKAN KOGYO SHIMBUN). Further, preferred examples of the releasing agent include silicon compounds, fluorine compounds and waxes (except natural waxes) which are used for producing toners which are described in the following patent documents: JP-B Nos. 59-38581, 04-32380, Japanese Patent Nos. 2838498 and 2949558, JP-A Nos. 50-117433, 52-52640, 57-148755, 61-62056, 61-62057, 61-118760, 02-42451, 03-41465, 04-212175, 04-214570, 04-263267, 05-34966, 05-119514, 06-59502, 06-161150, 06-175396, 06-219040, 06-230600, 06-295093, 07-36210, 07-43940, 07-56387, 07-56390, 07-64335, 07-199681, 07-223362, 07-287413, 08-184992, 08-227180, 08-248671, 08-248799, 08-248801, 08-278663, 09-152739, 09-160278, 09-185181, 09-319139, 09-319143, 10-20549, 10-48889, 10-198069, 10-207116, 11-2917, 11-44969, 11-65156, 11-73049 and 11-194542. These compounds may be used in combination.

Examples of the silicone compounds include a silicone oil, a silicone rubber, a silicone fine particles, a silicone-modified resin and a reactive silicone compound.

Examples of the silicone oil include an unmodified silicon oil, an amino-modified silicone oil, a carboxy-modified silicone oil, a carbinol-modified silicone oil, a vinyl-modified silicone oil, an epoxy-modified silicone oil, a polyether-modified silicone oil, a silanol-modified silicone oil, a methacryl-modified silicone oil, a mercapto-modified silicone oil, an alcohol-modified silicone oil, an alkyl-modified silicone oil and a fluorine-modified silicone oil.

Examples of the silicone-modified resin include silicone-modified resins produced by silicone-modifying resins, such as an olefinic resin, a polyester resin, a vinyl resin, a polyamide resin, a cellulose resin, a phenoxy resin, a vinyl chloride-vinyl acetate resin, an urethane resin, an acrylic resin, a styrene-acrylic resin and a copolymer resin thereof.

The fluorine compound is not restricted and may be properly selected depending on the application. Examples of the fluorine compound include a fluorocarbon oil, a fluorocarbon rubber, a fluorine-modified resin, a fluorosulfonic acid compound, a fluorosulfonic acid, a fluoric acid compound and salts thereof and an inorganic fluoride.

The wax is generally classified into the above-noted natural wax and a synthesized wax. The synthetic wax is classified into a synthetic hydrocarbon, a modified wax, a hydrogenated wax and other synthetic waxes produced from fats and oils. As the wax, from the viewpoint of the compatibility of the wax with a hydrophilic thermoplastic resin used as a thermoplastic resin for producing the toner image-receiving layer, a water-dispersible wax is preferred.

Examples of the synthetic hydrocarbon include a Fischer-Tropsch wax and a polyethylene wax.

Examples of the synthetic wax produced from fats and oils include an acid amide (such as stearamide) and an acid imide (such as anhydrous phthalimide).

The modified wax is not restricted and may be properly selected depending on the application. Examples of the modified wax include an amine-modified wax, an acrylic acid-modified wax, a fluorine-modified wax, an olefin-modified wax, a urethane-type wax and an alcohol-type wax.

The hydrogenated wax is not restricted and may be properly selected depending on the application. Examples of the hydrogenated wax include a hard castor oil, a castor oil derivative, stearic acid, lauric acid, myristic acid, palmitic acid, behenic acid, sebacic acid, undecylenic acid, heptyl acid, maleic acid and a highly maleinated oil.

The melting point of the releasing agent is, particularly from the viewpoint of the anti-offset properties and the conbeyability of the image-receiving sheet, preferably from 70° C. to 95° C., more preferably from 75° C. to 90° C.

As the releasing agent incorporated in the composition of the toner image-receiving layer, a derivative, an oxide, a purified product and a mixture of the above-exemplified releasing agent may be also used. These releasing agents may have a reactive substituent.

The amount of the releasing agent in the toner image-receiving layer is preferably from 0.1% to 10% by mass, more preferably from 0.3% to 8.0% by mass, still more preferably from 0.5% to 5.0% by mass, based on the mass of the toner image-receiving layer.

—Plasticizer—

The plasticizer is not restricted and may be properly selected from conventional plasticizers used for the resin depending on the application. The plasticizer has the function to control the fluidizing and softening of the toner image-receiving layer due to the heat and pressure applied on the toner image-receiving layer during fixing the toner.

Examples of a reference for selecting the plasticizer include literatures, such as “Kagaku Binran (Chemical Handbook)” (edited by The Chemical Society of Japan and published by Maruzen Co., Ltd.), “Plasticizer, Theory and Application” (edited by Koichi Murai and published by Saiwai Shobo), “Volumes 1 and 2 of Studies on Plasticizer” (edited by Polymer Chemistry Association) and “Handbook on Compounding Ingredients for Rubbers and Plastics” (edited by Rubber Digest Co.).

Some plasticizers are described as an organic solvent having a high-boiling point or a thermal solvent in some literatures. Examples of the plasticizer include esters (such as phthalate esters, phosphorate esters, aliphatic esters, abietate esters, adipate esters, sebacate esters, azelate esters, benzoate esters, butyrate esters, epoxidized aliphatic esters, glycolate esters, propionate esters, trimellitate esters, citrate esters, sulfonate esters, carboxylate esters, succinate esters, malate esters, fumarate esters, phthalate esters and stearate esters), amides (such as aliphatate amides and sulfonate amides); ethers; alcohols; lactones and polyethylene oxides which are described in patent documents, such as JP-A Nos. 59-83154, 59-178451, 59-178453, 59-178454, 59-178455, 59-178457, 62-174754, 62-245253, 61-209444, 61-200538, 62-8145, 62-9348, 62-30247, 62-136646, and 2-235694.

These plasticizers may be incorporated in the composition of the resin.

Further, a plasticizer having a relatively low molecular weight can be also used. The plasticizer has a molecular weight which is preferably lower than that of a binder resin which is plasticized by the plasticizer and preferably 15,000 or less, more preferably 5,000 or less. In addition, when a plasticizer is a polymer, the plasticizer is preferably the same polymer as that of the binder resin which is plasticized by the plasticizer. For example, for plasticizing a polyester resin, the plasticizer is preferably a polyester having a low molecular weight. Further, an oligomer can be also used as a plasticizer.

Besides the above-noted compounds, examples of the plasticizer which is commercially available include Adekacizer PN-170 and PN-1430 (manufactured and sold by Asahi Denka Kogyo Co., Ltd.); PARAPLEX G-25, G-30 and G-40 (manufactured and sold by C. P. Hall Co., Ltd.); and Ester Gum 8L-JA, Ester R-95, Pentalin 4851, FK 115, 4820, 830, Luisol 28-JA, Picolastic A75, Picotex LC and Crystalex 3085 (manufactured and sold by Rika Hercules Co., Ltd.).

The plasticizer may be optionally used for relaxating the stress and strain (i.e., a physical strain, such as a strain in elastic force and viscosity and a strain due to a material balance in the molecule and the backbone chain and pendant moiety of the binder) which are caused when the toner particles are embedded in the toner image-receiving layer.

In the toner image-receiving layer, the plasticizer may be finely (microscopically) dispersed, may be in the state of the micro-phase separation in a sea-island structure and may be compatibilized with other components, such as a binder resin.

The amount of the plasticizer in the toner image-receiving layer is preferably from 0.001% by mass to 90% by mass, more preferably from 0.1% by mass to 60% by mass, still more preferably from 1% by mass to 40% by mass, based on the mass of the toner image-receiving layer.

The plasticizer may be used for controlling slip properties (for improving the conveyability by reducing the friction), improving the offset of the toner at the fixing part of the fixing apparatus (peeling of the toner or the toner image-receiving layer to the fixing part) and controlling the curling balance and electrostatic charge (formation of a toner electrostatic image).

—Colorant—

The colorant is not restricted and may be properly selected depending on the application. Examples of the colorant include a fluorescent whitening agent, a white pigment, a colored pigment and a dye.

The fluorescent whitening agent is not restricted so long as the agent is a conventional compound having the absorption in the near-ultraviolet region and emitting a fluorescence having a wavelength of from 400 nm to 500 nm and may be properly selected from conventional fluorescent whitening agents. Preferred examples of the fluorescent whitening agent include the compounds described in the literature “The Chemistry of Synthetic Dyes, Volume V” (edited by K. Veen Rataraman, Chapter 8). The fluorescent whitening agent may be a commercially available product or a properly synthesized product. Examples of the fluorescent whitening agent include stilbene compounds, coumarin compounds, biphenyl compounds, benzo-oxazoline compounds, naphthalimide compounds, pyrazoline compounds and carbostyril compounds. Examples of the commercially available fluorescent whitening agent include white furfar-PSN, PHR, HCS, PCS and B (manufactured and sold by Sumitomo Chemicals Co., Ltd.) and UVITEX-OB (manufactured and sold by Ciba-Geigy Corp.).

The white pigment is not restricted and may be properly selected from conventional white pigments depending on the application. Examples of the white pigment include an inorganic pigment, such as titanium oxide and calcium carbonate.

The colored pigment is not restricted and may be properly selected from conventional colored pigments. Examples of the colored pigment include various pigments, such as an azo pigment, a polycyclic pigment, a condensed polycyclic pigment, a lake pigment and a carbon black which are described in JP-A No. 63-44653 and the like.

Examples of the azo pigment include an azo lake pigment (such as carmine 6B and red 2B), an insoluble azo pigment (such as monoazo yellow, disazo yellow, pyrazolone orange and Vulcan orange) and a condensed azo pigment (such as chromophthal yellow and chromophthal red).

Examples of the polycyclic pigment include a phthalocyanine pigment, such as copper phthalocyanine blue and copper phthalocyanine green.

Examples of the condensed polycyclic pigment include a dioxazine pigment (such as dioxazine violet), an isoindolinone pigment (such as isoindolinone yellow), a threne pigment, a perylene pigment, a perinone pigment and a thioindigo pigment.

Examples of the lake pigment include malachite green, rhodamine B, rhodamine G and Victoria blue B.

Examples of the inorganic pigment include an oxide (such as titanium dioxide and iron oxide red), a sulfate salt (such as precipitated barium sulfate), a carbonate salt (such as precipitated calcium carbonate) a silicate salt (such as a hydrous silicate salt and an anhydrous silicate salt) and a metal powder (such as aluminum powder, bronze powder, zinc powder, chrome yellow and iron blue).

These pigments may be used individually or in combination.

The dye is not restricted and may be properly selected from conventional dyes depending on the application. Examples of the dye include anthraquinone compounds and azo compounds. These dyes can be used individually or in combination.

Examples of the water-insoluble dye include a vat dye, a disperse dye and an oil-soluble dye. Specific examples of the vat dye include C. I. Vat violet 1, C. I. Vat violet 2, C. I. Vat violet 9, C. I. Vat violet 13; C. I. Vat violet 21, C. I. Vat blue 1, C. I. Vat blue 3, C. I. Vat blue 4, C. I. Vat blue 6, C. I. Vat blue 14, C. I. Vat blue 20 and C. I. Vat blue 35. Specific examples of the disperse dye include C. I. disperse violet 1, C. I. disperse violet 4, C. I. disperse violet 10, C. I. disperse blue 3, C. I. disperse blue 7 and C. I. disperse blue 58. Specific examples of the oil-soluble dye include C. I. solvent violet 13, C. I. solvent violet 14, C. I. solvent violet 21, C. I. solvent violet 27, C. I. solvent blue 11, C. I. solvent blue 12, C. I. solvent blue 25 and C. I. solvent blue 55.

Colored couplers used in the silver halide photography may also be used preferably as the dye.

The amount of the colorant in the toner image-receiving layer is preferably from 0.1 g/m² to 8 g/m², more preferably from 0.58 g/m² to 5 g/m².

When the amount of the colorant is less than 0.1 g/m², the light transmittance of the toner image-receiving layer may be high. On the other hand, when the amount is more than 8 g/m², handling properties, such as crazing and adhesion resistance may be impaired.

Examples of the filler include an organic filler and an inorganic filler which are conventional as a reinforcer, a bulking agent or a reinforcing agent for the binder resin. The filler may be properly selected by referring to “Handbook of Rubber and Plastics Additives” (edited by Rubber Digest Co.), “Plastics Blending Agents—Basics and Applications” (New Edition) (published by Taisei Co.) and “The Filler Handbook” (published by Taisei Co.).

Examples of the filler include an inorganic filler and an inorganic pigment. Specific examples of the inorganic filler or the inorganic pigment include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate and mullite. Among them, silica and alumina are most preferred. These fillers may be used individually or in combination. It is preferred that the filler has a small particle diameter. When the particle diameter of the filler is large, the surface of the toner image-receiving layer is easily roughened.

Examples of the silica include a spherical silica and an amorphous silica. The silica can be synthesized by a dry method, a wet method or an aerogel method. The silica may be also produced by treating the surface of the hydrophobic silica particles with a trimethylsilyl group or silicone. Preferred examples of the silica include a colloidal silica. The silica is preferably porous.

Examples of the alumina include an anhydrous alumina and a hydrated alumina. Examples of the crystallized anhydrous alumina include α-, β-, γ-, δ-, ξ-, η-, θ-, κ-, ρ- and χ-anhydrous alumina. The hydrated alumina is more preferred than the anhydrous alumina. Examples of the hydrated alumina include a monohydrated alumina and a trihydrate alumina. Examples of the monohydrated alumina include pseudo-boehmite, boehmite and diaspore. Examples of the trihydrated alumina include gibbsite and bayerite. The alumina is preferably porous.

The hydrated alumina can be synthesized by the sol-gel method in which ammonia is added to a solution of an aluminum salt to precipitate alumina or by a method of hydrolyzing an alkali aluminate. The anhydrous alumina can be obtained by heating to dehydrate a hydrated alumina.

The amount of the filler is preferably from 5 parts to 2,000 parts by mass, relative to 100 parts by mass in the dry mass of the binder resin in the toner image-receiving layer.

The crosslinking agent may be incorporated in the resin composition of the toner image-receiving layer for controlling the shelf stability and thermoplasticity of the toner image-receiving layer. Examples of the crosslinking agent include a compound containing in the molecule two or more reactive groups selected from the group consisting of an epoxy group, an isocyanate group, an aldehyde group, an active halogen group, an active methylene group, an acetylene group and other conventional reactive groups.

Examples of the crosslinking agent include also a compound containing in the molecule two or more groups which can form a bond through a hydrogen bond, an ionic bond or a coordination bond.

Specific examples of the crosslinking agent include a conventional compound as a coupling agent, a curing agent, a polymerizing agent, a polymerization promoter, a coagulant, a film-forming agent or a film-forming assistant which are used for the resin. Examples of the coupling agent include chlorosilanes, vinylsilanes, epoxisilanes, aminosilanes, alkoxy aluminum chelates, titanate coupling agents and other conventional crosslinking agents described in the literature “Handbook of Rubber and Plastics Additives” (edited by Rubber Digest Co.).

The toner image-receiving layer preferably comprises a charge control agent for controlling the transfer and adhesion of the toner and for preventing the adhesion of the toner image-receiving layer due to the charge.

The charge control agent is not restricted and may be properly selected from conventional various charge control agents depending on the application. Examples of the charge control agent include a surfactant, such as a cationic surfactant, an anionic surfactant, an amphoteric surfactant and a non-ionic surfactant; a polymer electrolyte and a conductive metal oxide. Specific examples of the charge control agent include a cationic antistatic agent, such as a quaternary ammonium salt, a polyamine derivative, a cation-modified polymethyl methacrylate, a cation-modified polystyrene; an anionic antistatic agent, such as an alkyl phosphate and an anionic polymer; and a non-ionic antistatic agent, such as an aliphatic ester and a polyethylene oxide.

When the toner is negatively charged, the charge control agent in the toner image-receiving layer is preferably a cationic or nonionic charge control agent.

Examples of the conductive metal oxide include ZnO, TiO₂, SnO₂, Al₂O₃, In₂O₃, SiO₂, MgO, BaO and MoO₃. These conductive metal oxides may be used individually or in combination. The conductive metal oxide may contain (dope) another different element, for example, ZnO may contain (dope) Al, In; TiO₂ may contain (dope) Nb, Ta; and SnO₂ may contain (dope) Sb, Nb and a halogen element.

—Other Additives—

The toner image-receiving layer may comprise also various additives for improving the stability of the output image or the stability of the toner image-receiving layer itself. Examples of the additive include various conventional antioxidants, an anti-aging agent, a deterioration inhibitor, an ozone-deterioration inhibitor, an ultraviolet light absorber, a metal complexes, a light stabilizer, an antiseptic agent and an anti-fungus agent.

The antioxidant is not restricted and may be properly selected depending on the application. Examples of the antioxidant include a chroman compound, a coumarin compound, a phenol compound (e.g., a hindered phenol), a hydroquinone derivative, a hindered amine derivative and a spiroindan compound. With respect to the antioxidant, there is a description in JP-A No. 61-159644.

The anti-aging agent is not restricted and may be properly selected depending on the application. Examples of the anti-aging agent include anti-aging agents described in the literature “Handbook of Rubber and Plastics Additives—Revised Second Edition” (published by Rubber Digest Co., 1993, pp. 76-121).

The ultraviolet light absorber is not restricted and may be properly selected depending on the application. Examples of the ultraviolet light absorber include a benzotriazol compound (see U.S. Pat. No. 3,533,794), a 4-thiazolidone compound (see U.S. Pat. No. 3,352,681), a benzophenone compound (see JP-A No. 46-2784) and an ultraviolet light absorbing polymer (see JP-A No. 62-260152).

The metal complex is not restricted and may be properly selected depending on the application. Proper examples of the metal complex include metal complexes described in patent documents, such as U.S. Pat. Nos. 4,241,155, 4,245,018, and 4,254,195; and JP-A Nos. 61-88256, 62-174741, 63-199248, 01-75568 and 01-74272.

Also, preferred examples of the ultraviolet light absorber or the light stabilizer include ultraviolet light absorbers or light stabilizers described in the literature “Handbook on Compounding Ingredients for Rubbers and Plastics, revised second edition” (published by Rubber Digest Co., 1993, pp. 122-137).

The toner image-receiving layer may optionally comprise the above-noted conventional additives for the photography. Examples of the additive for the photography include additives described in the literatures “Journal of Research Disclosure (hereinafter referred to as RD) No. 17643 (December, 1978), No. 18716 (November, 1979) and No. 307105 (November, 1989)”. These additives are specifically noted with respect to the pages of the Journal RD which are to be referred on a table as shown in the following Table 1.

TABLE 1

| | | Journal No. | | |
|---|---|---|---|---|
| Type of additives | | RD17643 | RD18716 | RD307105 |
| 1. | Whitening agent | pp. 24 | p. 648 right column | pp. 868 |
| 2. | Stabilizer | pp. 24-25 | p. 649 right column | pp. 868-870 |
| 3. | Light absorber | pp. 25-26 | p. 649 right column | pp. 873 |
| | (Ultraviolet light | | | |
| | absorber) | | | |
| 4. | Dye image stabilizer | pp. 25 | p. 650 right column | pp. 872 |
| 5. | Film hardener | pp. 26 | p. 651 left column | pp. 874-875 |
| 6. | Binder | pp. 26 | p. 651 left column | pp. 873-874 |
| 7. | Plasticizer, lubricant | pp. 27 | p. 650 right column | pp. 876 |
| 8. | Auxiliary coating | pp. 26-27 | p. 650 right column | pp. 875-876 |
| | agent (Surfactant) | | | |
| 9. | Antistatic agent | pp. 27 | p. 650 right column | pp. 876-877 |
| 10. | Matting agent | — | — | pp. 878-879 |

The toner image-receiving layer is disposed on the support by coating the support with the coating liquid containing a thermoplastic resin used for producing the toner image-receiving layer using a wire coater and by drying the resultant coating. The Minimum Film Forming Temperature (MFT) of the thermoplastic resin used in the present invention is preferably room temperature or higher during the storage of the image-receiving sheet before the printing and preferably 100° C. or lower during the fixing of the toner particles.

The mass of the dried coating as the toner image-receiving layer is preferably from 1 g/m² to 20 g/m², more preferably from 4 g/m² to 15 g/m².

The thickness of the toner image-receiving layer is not restricted and may be properly selected depending on the application. The thickness is preferably ½ or more of the diameter of the toner particles, more preferably from 1 time to 3 times the diameter of the toner particles. More specifically, the thickness is preferably from 1 μm to 50 μm, more preferably from 1 μm to 30 μm, still more preferably from 2 μm to 20 μm, most preferably from 5 μm to 15 μm.

[Physical Properties of Toner Image-Receiving Layer]

The 180-degree peel strength of the toner image-receiving layer at the temperature for the image-fixing at which the image is fixed on the fixing member is preferably 0.1 N/25 mm or less, more preferably 0.041 N/25 mm or less. The 180-degree peel strength can be measured according to the method described in JIS K 6887 using a surface material of the fixing member.

It is preferred that the toner image-receiving layer has the whiteness of a high degree. The whiteness is measured by the method described in JIS P 8123 and is preferably 85% or more. It is preferred that the spectral reflectance of the toner image-receiving layer is 85% or more in the wavelength range of from 440 nm to 640 nm and the difference between the maximum spectral reflectance of the toner image-receiving layer and the minimum spectral reflectance of the toner image-receiving layer in the above-noted wavelength range is within 5%. Further, it is more preferred that the spectral reflectance of the toner image-receiving layer is 85% or more in the wavelength range of from 400 to 700 nm and the difference between the maximum spectral reflectance of the toner image-receiving layer and the minimum spectral reflectance of the toner image-receiving layer in the above-noted wavelength range is within 5%.

With respect to the whiteness of the toner image-receiving layer, specifically, in the CIE 1976 (L* a* b*) color space, an L* value is preferably 80 or more, more preferably 85 or more, still more preferably 90 or more. The tone of the whiteness is preferably as neutral as possible and more specifically, with respect to the tone of the whiteness of the toner image-receiving layer, in the (L* a* b*) space, the value of (a*)²+(b*)² is preferably 50 or less, more preferably 18 or less, still more preferably 5 or less.

It is preferred that the toner image-receiving layer has high glossiness after the image-forming. With respect to the gloss level of the toner image-receiving layer, through the range of from the state in which the toner image-receiving layer is white (i.e., there is no toner in the toner image-receiving layer) to the state in which the toner image-receiving layer is black (i.e., there is full of the toner in the toner image-receiving layer), the 45-degree gloss level of the toner image-receiving layer is preferably 60 or more, more preferably 75 or more, still more preferably 90 or more.

However, the gloss level of the toner image-receiving layer is preferably 110 or less. When the gloss level is more than 110, the image has a metallic luster and such a quality of the image is undesirable.

The gloss level can be measured according to JIS Z 8741.

It is preferred that the toner image-receiving layer has high smoothness after the fixing. With respect to the smoothness of the toner image-receiving layer, through the range of from the state in which the toner image-receiving layer is white (i.e., there is no toner in the toner image-receiving layer) to the state in which the toner image-receiving layer is black (i.e., there is full of the toner in the toner image-receiving layer), the average roughness (Ra) of the toner image-receiving layer is preferably 3 μm or less, more preferably 1 μm or less, still more preferably 0.5 μm or less.

The average roughness can be measured, for example, according to the methods described in JIS B 0601, B 0651 and B 0652.

The toner image-receiving layer has preferably one of the physical properties described in the following items (1) to (6), more preferably several of them, most preferably all of them.

(1) The melt temperature (Tₘ) of the toner image-receiving layer is preferably 30° C. or more, more preferably a temperature which is higher than Tₘ of the toner by 20° C., or lower.

(2) The temperature at which the viscosity of the toner image-receiving layer is 1×10⁵ cp is preferably 40° C. or higher, more preferably a temperature which is lower than the temperature at which the viscosity of the toner is 1×10⁵ cp.

(3) The storage elasticity modulus (G′) of the toner image-receiving layer at the temperature for the image-fixing is preferably from 1×10² Pa to 1×10⁵ Pa and the loss elasticity modulus (G″) of the toner image-receiving layer at the temperature for the image-fixing is preferably from 1×10² Pa to 1×10⁵ Pa.

(4) The loss tangent (G″/G′) of the toner image-receiving layer is preferably from 0.01 to 10, wherein the loss tangent is the ratio of the loss elasticity modulus (G″) to the storage elasticity modulus (G′).

(5) The storage elasticity modulus (G′) of the toner image-receiving layer at the fixing temperature differs from the storage elasticity modulus (G′) of the toner at the fixing temperature, preferably by −50 to +2500.

(6) The inclination angle of the molten toner on the toner image-receiving layer is preferably 50° or less, more preferably 40° or less.

The toner image-receiving layer preferably satisfies the physical properties described in Japanese Patent No. 2788358 and JP-A Nos. 07-248637, 08-305067 and 10-239889.

The surface electrical resistance of the toner image-receiving layer is preferably in the range of from 1×10⁶ Ω/cm² to 1×10¹⁵ Ω/cm² (under conditions of 25° C. and 65% RH).

When the surface electrical resistance is less than 1×10⁶ Ω/cm², the amount of the toner transferred to the toner image-receiving layer is unsatisfactory, so that a disadvantage is caused wherein the density of the obtained toner image becomes easily too low. On the other hand, when the surface electrical resistance is more than 1×10¹⁵ Ω/cm², more charge than the necessity is generated in the toner image-receiving layer during the transfer, so that disadvantages are caused wherein the toner is transferred so unsatisfactorily that the density of the obtained image is low and the electrophotographic image-receiving label sheet is electrostatically charged, so that the image-receiving sheet adsorbs easily the dust. Moreover, in this case, miss field, multi feed, discharge marks and toner transfer dropout may occur during the copying.

The surface electrical resistance of the toner image-receiving layer can be measured according to the method described in JIS K 6911 as follows. The sample of the toner image-receiving layer is left under the condition where the temperature is 20° C. and the humidity is 65% for 8 hours or more and after applying a voltage of 100 V to the sample of the toner image-receiving layer for 1 minute under the same condition as the above-noted condition, the surface electrical resistance of the toner image-receiving layer can be measured using a micro-ammeter R8340 (manufactured and sold by Advantest Ltd.).

—Intermediate Layer —

According to the present invention, the intermediate layer comprising a polymer used for producing the intermediate layer may be disposed on a surface of the support. The intermediate layer may be, for example, between the support and the adhesion-improving layer, between the adhesion-improving layer and the cushion layer, between the cushion layer and the toner image-receiving layer, or between the toner image-receiving layer and the shelf stability improving layer. In the case of the image-receiving sheet for the electrophotography, which comprises the support, the toner image-receiving layer and the intermediate layer, the intermediate layer may be disposed, for example, between the support and the toner image-receiving layer.

The intermediate layer is disposed, for example, by preparing the coating liquid for producing the intermediate layer and by coating another layer with the prepared coating liquid. By using the coating liquid, relatively easily, the intermediate layer can be disposed on the support. Further, it becomes possible to cause the polymer for the intermediate layer to soak in the direction of the thickness of the support into the support.

The polymer for the intermediate layer is preferably suitable for using as the coating liquid comprising the polymer. Such a polymer for the intermediate layer is not restricted and may be properly selected depending on the application so long as by using the polymer, the coating liquid can be prepared. As the polymer used for the intermediate layer, for example, polymers of the same type as that of the polymers used for the toner image-receiving layer may be used. Among them, the above-noted water-soluble polymer and the above-noted water-dispersible polymer are preferred and the above-noted self-dispersible water-dispersible polyester emulsion and the above-noted water-dispersible acrylic resin are most preferred.

The polymer used for producing the intermediate layer may be used in combination with other polymer materials. In this case, the amount of the polymer used for the intermediate layer is generally larger than that of other polymer materials.

More specifically, the amount of the polymer used for the intermediate layer is preferably 20% by mass or more, more preferably from 30% by mass to 100% by mass, based on the mass of the intermediate layer.

It is preferred that the polymer used for the intermediate layer satisfies the requirements for physical properties disclosed in JP-A Nos. 05-127413, 08-194394, 08-334915, 08-334916, 09-171265, and 10-221877.

In the composition of the intermediate layer, so long as the function of the intermediate layer is not impaired, various components described in the above section of Toner Image-Receiving Layer may be optionally incorporated.

The thickness of the intermediate layer is not restricted and may be properly selected depending on the application. The thickness is preferably, for example, from 4 μm to 50 μm.

[Other Layers]

—Surface Protective Layer—

The surface protective layer may be disposed on the surface of the toner image-receiving layer for protecting the surface of the image-receiving sheet for the electrophotography according to the present invention, improving shelf stability, handling properties and conveyability thereof, and imparting writing properties and anti-offset properties thereto. The surface protective layer may have a single-layer structure or a laminated structure of two or more layers. The surface protective layer may comprise as a binder resin at least one of various thermoplastic resins and thermosetting resins which is preferably a resin of the same type as that of a resin used for the toner image-receiving layer. In this case, however, a resin used for the surface protective layer needs not to have the same thermodynamic properties or electrostatic properties as that of a resin used for the toner image-receiving layer and those properties of the surface protective layer can be respectively optimized.

The surface protective layer comprises preferably the above-noted particles and may comprise also the above-noted various additives which are usable for producing the toner image-receiving layer. Particularly, the surface protective layer may comprise together with the above-noted particles according to the present invention.

The most outer surface layer of the image-receiving sheet for the electrophotography (e.g., the surface protective layer when it is disposed) has preferably good compatibility with the toner from the viewpoint of good fixability of the toner image. More specifically, the most outer surface layer has preferably a contact angle with the molten toner of from 0° to 40°.

—Back Layer—

The back layer in the image-receiving sheet the electrophotography according to the present invention is preferably disposed on a surface of the support, which is opposite to another surface of the support on which the toner image-receiving layer is disposed, for imparting back side-output suitability to the image-receiving sheet and improving the image quality of the back side-output, curling balance and conveyability of the image-receiving sheet.

The color of the back layer is not restricted and may be properly selected depending on the application. When the image-receiving sheet for the electrophotography according to the present invention is an image-receiving sheet of the both-side output type forming the image also on the back side, however, also the color of the back layer is preferably white. The back layer has preferably whiteness of 85% or more and spectral reflectance of 85% or more, like the image-receiving layer.

Moreover, for improving both-side output suitability, the back layer may have a composition same as that of the front side of the sheet, which comprises the toner image-receiving layer. The back layer may comprise besides the above-noted particles, the above-explained various additives. It is appropriate that as the additives, particularly a charge control agent is used. The back layer may have a single-layer structure or a laminated structure of two or more layers.

When for preventing the offset during the image-fixing, an oil having release properties is applied to the fixing roller, the back layer may have oil absorbency.

—Adhesion-Improving Layer—

The adhesion-improving layer in the image-receiving sheet for the electrophotography according to the present invention is disposed preferably for improving adhesion between the support and the toner image-receiving layer. The adhesion-improving layer may comprise the above-noted various additives, particularly preferably the crosslinker. Further, it is preferred that in the image-receiving sheet for the electrophotography according to the present invention, for improving the toner receptivity, a cushion layer is disposed between the adhesion improving layer and the image-receiving layer.

In the image-receiving sheet for the electrophotography according to the present invention, each of the above-noted layers disposed between the support and the toner image-receiving layer has preferably at least one of a glass transition temperature and a melting point which are the temperature for the image-fixing or lower. When the image is formed using such an image-receiving sheet for the electrophotography, during the image-fixing, the above-noted layer having at least one of a glass transition temperature and a melting point which are the temperature for the image-fixing or lower is molten and the particles projecting out of the most outer surface of the toner image-receiving layer is embedded in the toner image-receiving layer, so that the glossiness and smoothness of the surface of the image-receiving sheet for the electrophotography is improved

The thickness of the image-receiving sheet for the electrophotography according to the present invention is not restricted and may be properly selected depending on the application. The thickness is preferably from 50 μm to 500 μm, more preferably from 100 μm to 350 μm.

Using the image-receiving sheet for the electrophotography according to the present invention, a image having an excellent adhesion resistance and a high image quality can be formed.

<Toner>

The image-receiving sheet for the electrophotography according to the present invention is used by causing the toner image-receiving layer to receive the toner during the printing and copying.

The toner comprises at least a binder resin and a colorant, and optionally a releasing agent and other components.

—Binder Resin for Toner—

The binder resin is not restricted and may be selected from resins used usually for producing the toner depending on the application. Examples of the binder resin include homo-polymers or copolymers produced by polymerizing or copolymerizing a vinyl monomer or two or more vinyl monomers selected from the group consisting of vinyl monomers, such as styrenes, such as styrene and parachlorostyrene; vinyl esters, such as vinyl naphthalene, vinyl chloride, vinyl bromide, vinyl fluoride, vinyl acetate, vinyl propioniate, vinyl benzoate and vinyl butyrate; methylene aliphatic carboxylate esters, such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate and butyl methacrylate; vinyl nitriles, such as acrylonitrile, methacrylonitrile and acrylamide; vinyl ethers, such as vinyl methyl ether, vinyl ethyl ether and vinyl isobutyl ether; N-vinyl compounds, such as N-vinyl pyrrole, N-vinyl carbazole, N-vinyl indole and N-vinyl pyrrolidone; and vinyl carboxylic acids, such as methacrylic acid, acrylic acid and cinnamic acid. Examples of the binder resin include also various polyesters. The above-noted examples of the binder resin may be used in combination with various waxes.

Among these resins, a resin of the same type as that of the resin used for producing the toner image-receiving layer according to the present invention is preferably used.

—Colorant for Toner—

The colorant used for the toner is not restricted and may be properly selected from colorants used usually for producing the toner depending on the application. Examples of the colorant include various pigments, such as carbon black, chrome yellow, hansa yellow, benzidine yellow, threne yellow, quinoline yellow, Permanent Orange GTR, Pyrazolone orange, vulcan orange, watchung red, permanent red, Brilliant Carmine 3B, Brilliant Carmine 6B, Du Pont Oil Red, Pyrazolone Red, Lithol Red, Rhodamine B lake, Lake Red C, Rose Bengal, aniline blue, ultra marine blue, chalco oil blue, methylene blue chloride, phthalocyanine blue, phthalocyanine green, malachite green oxalate; and various dyes, such as acridine dyes, xanthene dyes, azo dyes, benzoquinone dyes, azine dyes, anthraquinone dyes, indigo dyes, thioindigo dyes, dioxazine dyes, thiazine dyes, azomethine dyes, phthalocyanine dyes, aniline black dyes, polymethine dyes, triphenylmethane dyes, diphenylmethane dyes and thiazole dyes.

These colorants may be used individually or in combination.

The amount of the colorant is not restricted and may be properly selected depending on the application. The amount is preferably from 2% to 8% by mass, based on the mass of the toner. When the amount of the colorant is less than 2% by mass, the coloring power of the toner may be weakened. On the other hand, when the amount is more than 8% by mass, the clarity of the toner may be impaired.

—Releasing Agent for Toner—

The releasing agent used for the toner is not restricted and may be properly selected from releasing agents used usually for the toner depending on the application. Particularly effective examples of the releasing agent include a highly crystalline polyethylene wax having a relatively low molecular weight, a Fischer-Tropsch wax, amide wax and a polar wax containing nitrogen, such as a compound having a urethane bond.

The polyethylene wax has a molecular weight of preferably 1000 or less, more preferable from 300 to 1000.

The compound having a urethane bond is preferred in that even if the compound has a low molecular weight, the compound can maintain a solid state by a strong cohesive force of a polar group and such a compound having a high melting point for the molecular weight thereof can be produced. The compound has a molecular weight of preferably from 300 to 1000. Examples of a combination of materials for producing the compound having a urethane bond include a combination of a diisocyanic acid compound and a monohydric alcohol, a combination of a monoisocyanic acid compound and a monohydric alcohol, a combination of a dihydric alcohol and a monoisocyanic acid compound, a combination of a trihydric alcohol and a monoisocyanic acid compound and a combination of a triisocyanic acid compound and a monohydric alcohol. However, for preventing the molecular weight of the compound from becoming too large, a combination of a compound having a multiple functional group and another compound having a single functional group is preferred and it is important that the total amount of the functionality in a combination is always equivalent.

Examples of the monoisocyanic acid compound include dodecyl isocyanate, phenyl isocyanate (and derivatives thereof), naphthyl isocyanate, hexyl isocyanate, benzyl isocyanate, butyl isocyanate and allyl isocyanate.

Examples of the diisocyanic acid compound include tolylene diisocyanate, 4,4′ diphenylmethane diisocyanate, toluene diisocyanate, 1,3-phenylene diisocyanate, hexamethylene diisocyanate, 4-methyl-m-phenylene diisocyanate and isophorone diisocyanate.

Examples of the monohydric alcohol include methanol, ethanol, propanol, butanol, pentanol, hexanol and heptanol.

Examples of the dihydric alcohol include various glycols, such as ethylene glycol, diethylene glycol, triethylene glycol and trimethylene glycol.

Examples of the trihydric alcohol include trimethylol propane, triethylol propane and trimethanol ethane.

These urethane compounds may be mixed with a resin or a colorant during the kneading like a usual releasing agent to be used as a kneaded-ground type toner. When these urethane compounds are used for producing the toner produced according to the emulsion polymerization-cohesion and melting method, an aqueous dispersion of the releasing agent particles having a size of 1 μm or less is prepared according to a method comprising dispersing in water the urethane compound together with an ionic surfactant and a polymeric electrolyte, such as a polymeric acid and a polymeric base, thereby obtaining a dispersion of a releasing agent, heating the obtained dispersion to the melting point of the urethane compound or higher, and grinding the urethane compound until the urethane compound becomes in the form of fine particles by subjecting the above-noted dispersion to a strong shearing using a homogenizer or a dispersing apparatus of a pressure discharge type, and the prepared dispersion of fine particles of the releasing agent is used in combination with a dispersion of resin particles and a dispersion of colorant particles to produce the toner produced according to the emulsion polymerization-cohesive melting method.

—Other Components for Toner—

The toner may comprise other components, such as an inner additive, a charge control agent and inorganic fine particles. Examples of the inner additive include a magnetic material, such as a metal, such as ferrite, magnetite, reduced iron, cobalt, nickel and manganese; an alloy thereof; and a compound containing these metals.

Examples of the charge control agent include various charge control agents used usually, such as a quaternary ammonium salt, a nigrosine compound, a dye comprising a complex of a metal (such as aluminum, iron and chromium) and a triphenylmethane pigment. It is preferred that the charge control agent is difficulty dissolved in water, from the view point of suppressing the ion strength in the toner, which may affect the stability of the charge control agent during the cohesion and the melting and reducing the pollution by the waste water.

Examples of the inorganic fine particles include all usual outer additives of the toner surface, such as silica, alumina, titania, calcium carbonate, magnesium carbonate and tricalcium phosphate. These particles are preferably used in the form of a dispersion produced by dispersing the particles in an ionic surfactant, a polymer acid or a polymer base.

Further, the toner may comprise as an additive a surfactant for the emulsion polymerization, the seed emulsion polymerization, the pigment dispersion, the resin particles dispersion, the releasing agent dispersion, the cohesion and stabilization thereof. Examples of the surfactant include an anionic surfactant, such as a sulfate ester surfactant, a sulfonate ester surfactant, a phosphate ester surfactant and a soap; a cationic surfactant, such as an amine salt surfactant and a quaternary ammonium salt surfactant. It is also effective the above-exemplified surfactants are used in combination with a nonionic surfactant, such as a polyethylene glycol surfactant, an alkylphenol ethylene oxide adduct surfactant and a polyhydric alcohol surfactant. As a dispersing unit for dispersing the surfactant in the toner, a general unit, such as a rotary shearing type homogenizer; and a ball mill, a sand mill and a dyno mill, all of which contain the media can be used.

The toner may comprise optionally an outer additive. Examples of the outer additive include inorganic particles and organic particles. Examples of the inorganic particles include particles of SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄ and MgSO₄. Examples of the organic particles include particles of an aliphatic acid and derivatives thereof; a metal salt of the above-notea aliphatic acid and derivatives thereof; and a resin, such as a fluorine resin, a polyethylene resin and an acrylic resin.

The average particle diameter of the above-noted particles is preferably from 0.01 μm to 5 μm, more preferably from 0.1 μm to 2 μm.

The manufacturing method of the toner is not restricted and may be properly selected depending on the application. However, it is preferred that the toner is produced according to a manufacturing method of the toner comprising (i) preparing a dispersion of cohesive particles of a resin by forming cohesive particles in a dispersion of resin particles, (ii) forming attached particles by mixing the above-prepared dispersion of cohesive particles with a dispersion of fine particles, so that the fine particles attaches to the cohesive particles, thereby forming attached particles and (iii) forming toner particles by heating the attached particles to melt the attached particles.

—Physical Properties of Toner—

The toner according to the present invention has a volume average particle diameter of preferably from 0.5 μm to 10 μm. When the volume average particle diameter of the toner is too small, handling properties of the toner (, such as replenish properties, cleaning properties and fluidity) may be affected adversely and the productivity of the particles may be lowered. On the other hand, when the volume average particle diameter of the toner is too large, the quality and resolution of the image due to graininess and transferability may be affected adversely.

It is preferred that the toner according to the present invention satisfies the above-noted range of a volume average particle diameter and has a distribution index of the volume average particle diameter (GSDv) of 1.3 or less.

The ratio (GSDv/GSDn) of the distribution index of the volume average particle diameter (GSDv) to the distribution index of the number average particle diameter (GSDn) is preferably 0.95 or more.

It is preferred that the toner according to the present invention satisfies the above-noted range of the volume average particle diameter and has an average (1.00 to 1.50) of the shape factor calculated according to the following equation:
Shape factor=(π×L²)/(4×S)

wherein L represents the maximum length of the toner particles and S represents the projected area of the toner particles.

When the toner satisfies the above-noted conditions, an effect on the image quality, such as graininess and resolution particularly can be obtained and moreover, dropout or blur which may accompany with the transfer is difficulty caused. Further, in this case, the handling properties of the toner may be difficulty affected adversely, even if the average particle diameter of the toner is not small.

From the viewpoint of improving the image quality and preventing the offset during the image-fixing, it is appropriate that the toner has storage elasticity modulus G′ (as measured at a circular frequency of 10 rad/sec) of 1×10² Pa to 1×10⁵ Pa at 150° C.

(Manufacturing Method of Image-Receiving Sheet for Electrophotography)

The manufacturing method of the image-receiving sheet for the electrophotography according to the present invention comprises at least coating the support with the coating liquid for producing the toner image-receiving layer and optionally other steps.

—Process for Forming Toner Image—

The coating is performed by coating the support with the coating liquid for producing the toner image-receiving layer.

The coating liquid for producing the toner image-receiving layer is not restricted so long as by the coating, the toner image-receiving layer can be disposed on the support and may be properly selected depending on the application. Examples of the coating liquid include a coating liquid comprising the above-noted polymer for producing the toner image-receiving layer.

The coating method is not restricted and may be properly selected from conventional methods depending on the application. Examples of the coating method include curtain coating, dip coating, spin coating and roll coating.

In the manufacturing method of the image-receiving sheet for the electrophotography according to the present invention, the coating liquid for producing the toner image-receiving layer comprises the particles having a particle size distribution (standard deviation/volume average particle diameter) of 0.4 or less and is filtered. When the particle size distribution (standard deviation/volume average particle diameter) is 0.4 or less, the filtering characteristics of the coating liquid for producing the toner image-receiving layer are improved and the clogging of the filter is avoided, so that the invade of foreign matters into the surface of the toner image-receiving layer can be prevented.

The filtration is preferably performed under the condition where the effective filtration accuracy is 40 μm or less and for this condition, preferred examples of the filter include a 400-mesh filter.

According to the manufacturing method of the image-receiving sheet for the electrophotography according to the present invention, the filtering characteristics of the coating liquid for producing the toner are excellent and the removal of foreign matters is easy, so that an image-receiving sheet for the electrophotography which is excellent in adhesion resistance and can form an image having a high image quality, can be effectively produced.

(Image-Forming Process)

The image-forming process according to the present invention comprises forming the toner image and fixing the image by smoothing the image surface, and optionally other steps.

—Forming Toner Image—

The forming of the toner image is performed by forming the toner image in the toner image-receiving sheet for the electrophotography according to the present invention.

The forming of the toner image is not restricted so long as by the forming, the toner image can be formed in the image-receiving sheet for the electrophotography and may be properly selected depending on the application. Examples of the forming of the toner image include a usual method used for the electrophotography, such as a direct transfer method in which the toner image formed on the developing roller is directly transferred to the image-receiving sheet, for the electrophotography and an intermediate transfer belt method in which the toner image formed on the developing roller is primary-transferred to the intermediate transfer belt and the primary-transferred image is transferred to the image-receiving sheet for the electrophotography. Among them, from the viewpoint of environmental stability and enhancing the image quality, the intermediate transfer belt method is preferably used.

—Fixing the Image by Smoothing the Image Surface—

The fixing of the image by smoothing the image surface is performed by heating, pressuring and cooling the toner image and by peeling the image-receiving sheet from the belt using an apparatus configured to fix the image by smoothing the image surface which is equipped with a heating-pressing unit, a belt and a cooling unit.

The apparatus configured to fix the image by smoothing the image surface comprises a heating-pressing unit, a belt, a cooling unit, a cooling-peeling portion and optionally other units.

The heating-pressing unit is not restricted and may be properly selected depending on the application. Examples of the heating-pressing unit include a pair of heating rollers and a combination of a heating roller and a pressing roller.

The cooling unit is not restricted and may be properly selected depending on the application. Examples of the cooling unit include a cooling unit which can blow a cool air and can control the cooling temperature, and a heat sink.

The cooling-peeling portion is not restricted and may be properly selected depending on the application. Examples of the cooling-peeling portion include a section which is near of the tension roller where the image-receiving sheet for the electrophotography is peeled from the belt by own stiffness (nerve) of the image-receiving sheet.

For contacting the toner image with a heating-pressing unit of the apparatus configured to fixing the image by smoothing the image surface, the image-receiving sheet is preferably pressed. The method for pressing the image-receiving sheet is not restricted and may be properly selected depending on the application; however, a nip pressure is preferably used. The nip pressure is, from the viewpoint of forming an image which is excellent in water resistance and surface smoothness and has excellent gloss, preferably from 1 kgf/cm² to 100 kgf/cm², more preferably from 5 kgf/cm² to 30 kgf/cm². The heating temperature in the heating-pressing unit is a temperature which is higher than the softening point of the polymer used for the toner image-receiving layer and is varied depending on the type of the polymer used for the toner image-receiving layer, however is usually preferably from 80° C. to 200° C. The cooling temperature in the cooling unit is preferably a temperature which is not higher than 80° C. at which the polymer layer as the toner image-receiving layer is satisfactorily set, more preferably from 20° C. to 80° C.

The belt comprises a heat-resistant support film and a mold-releasing layer disposed on the support film.

The material for the support film is not restricted so long as the material has heat resistance and may be properly selected depending on the application. Examples of the material include polyimide (PI), polyethylene naphthalate (PEN), polyethylene terephthalate (PET), polyether ether ketone (PEEK), polyether sulfone (PES), poly ether imide (PEI) and poly parabanic acid (PPA).

The mold-releasing layer comprises preferably at least one selected from the group consisting of a silicone rubber, a fluorine rubber, a fluorocarbon siloxane rubber, a silicone resin and a fluorine resin. Among them, the following aspects i) and ii):

i) a fluorocarbon siloxane rubber layer disposed on the surface of the belt and ii) a silicone rubber layer disposed on the surface of the belt and a fluorocarbon siloxane rubber layer disposed on the surface of the silicone rubber layer, are preferred.

As the fluorocarbon siloxane rubber of the fluorocarbon siloxane rubber layer, a fluorocarbon siloxane rubber in which the backbone chain has at least one of a perfluoroalkyl ether group and a perfluoroalkyl group, is preferred.

The fluorocarbon siloxane rubber is preferably a cured form of a fluorocarbon siloxane rubber composition comprising the following components (A)-(D):

(A) a fluorocarbon polymer comprising mainly a fluorocarbon siloxane represented by the following formula (1) and having an unsaturated aliphatic hydrocarbon group,

(B) at least one of organopolysiloxane and fluorocarbon siloxane which have two or more ≡SiH groups in the molecule, wherein the amount of a ≡SiH group is from one to four times (in mole) the amount of the unsaturated aliphatic hydrocarbon group in the above-noted fluorocarbon siloxane rubber composition, (C) a filler, and (D) an effective amount of catalyst.

The fluorocarbon polymer as the component (A) comprises mainly a fluorocarbon siloxane containing a recurring unit represented by the following formula (1) and contains an unsaturated aliphatic hydrocarbon group.

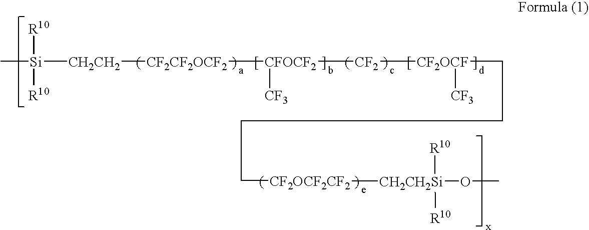

In formula (1), R¹⁰ represents an unsubstituted or substituted C₁-C₈ monovalent hydrocarbon group and is preferably a C₁-C₈ alkyl group or a C₂-C₃ alkenyl group, most preferably a methyl group. a and e are respectively an integer of 0 or 1, b and d are respectively an integer of 1 to 4 and c is an integer of 0 to 8. x is preferably an integer of 1 or more, more preferably an integer of 10 to 30.

Examples of the component (A) include a compound represented by the following formula (2):

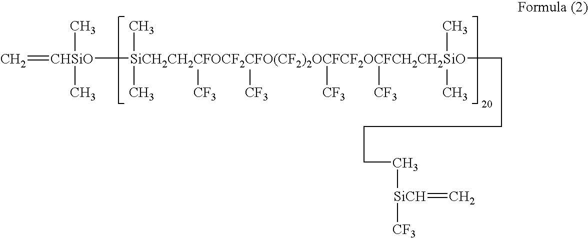

With respect to the component (B), examples of the organopolysiloxane having ≡SiH groups include an organohydrogen polysiloxane having in the molecule at least two hydrogen atoms bonded to a silicon atom.

In the fluorocarbon siloxane rubber composition, when the fluorocarbon polymer as the component (A) has an unsaturated aliphatic hydrocarbon group, as a curing agent, the above-noted organohydrogen polysiloxane is preferably used. In other words, the cured form is produced by an addition reaction between the unsaturated aliphatic hydrocarbon group of the fluorocarbon siloxane and a hydrogen atom bonded to a silicon atom in the organohydrogen polysiloxane.

Examples of the organohydrogen polysiloxane include various organohydrogen polysiloxanes used for curing a silicone rubber composition which is cured by an addition reaction.

The amount of the organohydrogen polysiloxane is an amount by which the number of ≡SiH groups in the organohydrogen polysiloxane is preferably at least one, most preferably from 1 to 5, relative to one unsaturated aliphatic hydrocarbon group in the fluorocarbon siloxane of the component (A).

Also, with respect to the component (B), preferred examples of the fluorocarbon siloxane having the ≡SiH groups include a fluorocarbon siloxane having a structure of the recurring unit represented by the formula (1), and a fluorocarbon siloxane having a structure of the recurring unit represented by the formula (1) in which R¹⁰ is a dialkylhydrogen siloxy group and the terminal group is a ≡SiH group, such as a dialkylhydrogen siloxy group or a silyl group. Such a preferred fluorocarbon siloxane can be represented by the following formula (3).

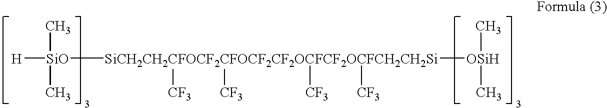

As the filler which is the component (C), various fillers used for a usual silicone rubber composition can be used. Examples of the filler include a reinforcing filler, such as a mist silica, a precipitated silica, a carbon powder, titanium dioxide, aluminum oxide, a quartz powder, talc, sericite and bentonite; and a fiber filler, such as an asbesto, a glass fiber, and an organic fiber.

Examples of the catalyst as the component (D) include an element belonging to Group VIII in the Periodic Table and a compound thereof, such as chloroplatinic acid; alcohol-modified chloroplatinic acid; a complex of chloroplatinic acid with an olefin; platinum black and palladium which are respectively supported on a carrier, such as alumina, silica and carbon; a complex of rhodium with an olefin, chlorotris(triphenylphosphine) rhodium (Wilkinson catalyst) and rhodium (III) acetyl acetonate, which are conventional catalysts for the addition reaction. It is preferred that these complexes are dissolved in a solvent, such as an alcohol compound, an ether compound or a hydrocarbon compound to be used.

The fluorocarbon siloxane rubber composition is not restricted and may be properly selected depending on the application, and optionally may comprise various additives. Examples of the various additives include a dispersing agent, such as a diphenylsilane diol, a low polymer of dimethyl polysiloxane in which the terminal of the molecule chain is blocked with a hydroxyl group, and a hexamethyl disilazane; a heat resistance improver, such as ferrous oxide, ferric oxide, cerium oxide and iron octylate; and a colorant, such as a pigment.

The belt can be obtained by coating a heat-resistant support film with the fluorocarbon siloxane rubber composition and by curing the resultant coated support film by the heating. Further optionally, the belt can be obtained by coating the support film with a coating liquid prepared by diluting the fluorocarbon siloxane rubber composition with a solvent, such as m-xylene hexafluoride and benzotrifluoride, according to a general coating method, such as spray coating, dip coating and knife coating. The heating-curing temperature and time may be properly selected from the ranges of from 100° C. to 500° C. (temperature) and from 5 seconds to 5 hours (time) depending on the type of the support film and the manufacturing method of the belt.

The thickness of the mold-releasing layer disposed on the surface of the heat-resistant support film is not restricted and may be properly selected depending on the application. For obtaining an advantageous fixing properties of the image by suppressing the release characteristics of the toner or by preventing the off-set of the toner component, the thickness is preferably from 1 μm to 200 μm, more preferably from 5 μm to 150 μm.

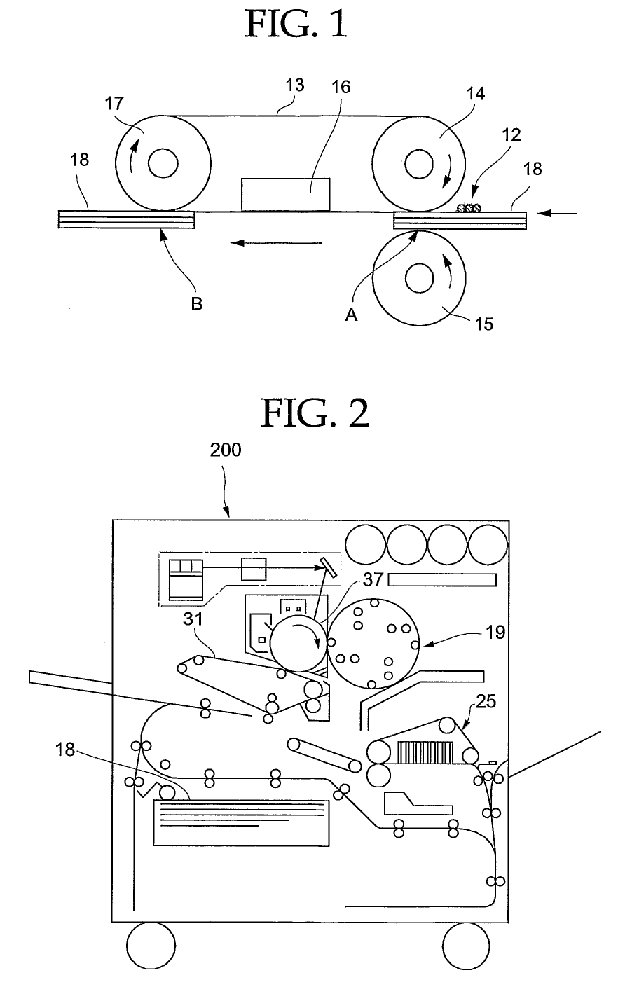

Here, with respect to an example of the apparatus configured to fix the image by smoothing the image surface, which is equipped with a typical fixing belt and is used in the process for forming the image according to the present invention, explanations are given in detail with referring to FIG. 1.

First, by an image-forming apparatus (not illustrated in FIG. 2), the toner 12 is transferred to the image-receiving sheet for the electrophotography 1. The image-receiving sheet 1 to which the toner 12 is adhered is conveyed to the point A by a conveying unit (not illustrated in FIG. 1) and passes through between the heating roller 14 and the pressing roller 15 to be heated and pressed at the temperature (fixing temperature) and under the pressure, wherein the temperature and pressure are enough high to soften satisfactorily the toner image-receiving layer of the image-receiving sheet 1 and the toner 12.

Here, the fixing temperature means a temperature of the surface of the toner image-receiving layer measured in a nip space between the heating roller 14 and the pressing roller 15 at the point A and is preferably from 80° C. to 190° C., more preferably from 100° C. to 170° C. The (fixing) pressure means a pressure of the surface of the toner image-receiving layer measured also in a nip space between the heating roller 14 and the pressing roller 15 at the point A and is preferably from 1 kgf/cm² to 10 kgf/cm², more preferably from 2 kgf/cm² to 7 kgf/cm².

The image-receiving sheet 11 which is thus heated and pressured is, next, conveyed by the fixing belt 13 to the cooling unit 16 and during the conveying of the image-receiving sheet 1, in the image-receiving sheet 1, a mold-releasing agent (not illustrated in FIG. 1) dispersed in the toner image-receiving layer is satisfactorily heated and molten. The molten mold-releasing agent is gathered to the surface of the toner image-receiving layer, so that in the surface of the toner image-receiving layer, a layer (film) of the mold-releasing agent is formed. The image-receiving sheet 1 conveyed to the cooling unit 16 is cooled by the cooling unit 16 to a temperature which is, for example, not higher than either the softening point of a binder resin used for producing the toner image-receiving layer or the toner, or the temperature which is higher than the glass transition point of the above-noted binder resin by 10° C., wherein the temperature to which the image-receiving sheet 1 is cooled is preferably from 20° C. to 80° C., more preferably room temperature (25° C.). Thus, the layer (film) of the mold-releasing agent formed in the surface of the toner image-receiving layer is cooled and set, thereby forming the mold-release agent layer.

The cooled image-receiving sheet 1 is conveyed by the fixing belt 13 further to the point B and the fixing belt 13 moves along the tension roller 17. Accordingly, at the point B, the image-receiving sheet 1 is peeled from the fixing belt 13. It is preferred that the diameter of the tension roller 17 is so small designed that the image-receiving sheet 1 can be peeled from the fixing belt 13 by own stiffness (nerve) of the image-receiving sheet 1.

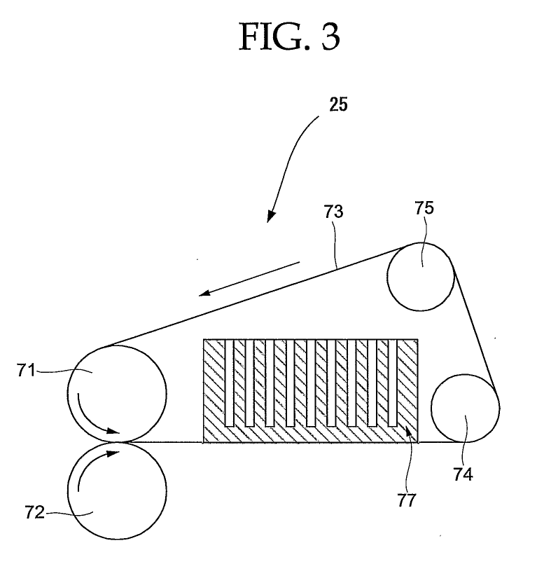

An apparatus configured to fix the image by smoothing the image surface shown in FIG. 3 can be used in an image-forming apparatus (e.g., a full-color laser printer DCC-500 (manufactured and sold by Fuji Xerox Co., Ltd.)) shown in FIG. 2 by converting the image-forming apparatus to a part of the belt fixing in the image-forming apparatus.

As shown in FIG. 2, the image-forming apparatus 200 includes photoconductive drum 37, development device 19, intermediate transfer belt 31, the image-receiving sheet for the electrophotography 18, and the apparatus configured to fix the image by smoothing the image surface 25.

FIG. 3 shows the apparatus configured to fix the image by smoothing the image surface 25 which can be converted to the belt fixing part of the image-forming apparatus 200 in FIG. 2.

As shown in FIG. 3, the apparatus configured to fix the image by smoothing the image surface 25 comprises heat roller 71, peeling roller 74, tension roller 75, endless belt 73 supported rotatably by the tension roller 75 and pressure roller 72 contacted by pressure to the heat roller 71 through the endless belt 73.

Cooling heatsink 77 which forces the endless belt 73 to cool is arranged inside the endless belt 73 between the heat roller 71 and the peeling roller 74. The cooling heatsink 77 constitutes the cooling and sheet-conveying unit for cooling and conveying the image-receiving sheet for the electrophotography 18.

In the apparatus configured to fix the image by smoothing the image surface 25 as shown in FIG. 3, the image-receiving sheet for the electrophotography bearing a color toner image transferred and fixed on the surface of the image-receiving sheet, is so introduced into a press-contacting portion (or nip portion) between the heat roll 71 and the pressure roll 72 contacted by pressure to the heat roller 71 through the endless belt 73 that the color toner image in the image-receiving sheet faces to the heat roller 71, wherein while the image-receiving sheet passes through the press-contacting portion between the heat roller 71 and the pressure roller 72, the color toner image is heated and fused to be fixed on the image-receiving sheet for the electrophotography.

Thereafter, the image-receiving sheet for the electrophotography bearing the color toner image fixed in the image-receiving layer of the image-receiving sheet by heating the toner of the color toner image to a temperature of substantially from 120 to 130° C. at the press-contacting portion between the heat roller 71 and the pressure roller 72 is conveyed by the endless belt 73, while the toner image-receiving layer in the surface of the image-receiving label sheet is adhered to the surface of the endless belt 73. During the conveying of the image-receiving sheet, the endless belt 73 is forcedly cooled by the cooling heatsink 77 and the color toner image and the image-receiving layer are cooled and set, so that the image-receiving sheet for the electrophotography is peeled from the endless belt 73 by the peeling roller 74 and own stiffness (nerve) of the image-receiving sheet.

The surface of the endless belt 73 after the peeling of the image-receiving sheet is cleaned by removing a residual toner therefrom using a cleaner (not illustrated in FIG. 3) and prepared for the next fixing of the image by smoothing the image surface.

According to the image-forming process according to the present invention, even if by using an image-forming apparatus equipped with no fixing oil, not only the release characteristics of the image-receiving sheet for the electrophotography and the toner can be suppressed or the off-set of the image-receiving sheet for the electrophotography and the toner components can be prevented, so that a stable feeding of the image-receiving sheet can be obtained, but also an image which is excellent in anti-crazing due to humidity change properties, anti-adhesion properties, anti-crazing properties and gloss level, and has a similar high image-quality to a print of a silver salt photography can be formed.

(Image-Forming System for Electrophotography)

The image-forming system for the electrophotography according to the present invention comprises at least a providing unit of the information from the user and an image-forming apparatus, an image-treating and image output-controlling unit, an accounting unit and optionally other units.

The image-forming system for the electrophotography is not restricted and may be properly selected depending on the application. Examples of the system include a photograph print system for the shop (manufactured and sold by Fuji Photo Film Co., Ltd.; trade name: Photo Recipe).

The apparatus configured to fix the image by smoothing the image surface in the image-forming system for the electrophotography according to the present invention is substantially the same as the above-noted apparatus configured to fix the image by smoothing the image surface and comprises the heating-pressuring unit, the belt and the cooling unit.

The above-noted providing unit of the information from the user is a unit for providing the information from the user into the image-forming apparatus. Examples of the providing unit of the information from the user include the manual in-put by the user (through the touch-panel monitor), the on-line, the internet and the personal data assistant. Examples of the information from the user include the surface condition of the sheet (e.g., a glossy surface, a matted surface, a embossed surface), the number of the sheets, the size of the sheet (e.g., A4, B4, A3 and B5) and the type of the document described on the sheet.

The above-noted image-treating and image output-controlling unit is a unit by which digital image data are drawn into the apparatus and with respect to the drawn data, the image-treating and the image output-controlling are performed.

The digital image data are not restricted and may be properly selected depending on the application. Preferred examples of the digital image data include photographed data and photographed data treated with an additional processing.

Examples of the digital image data include (1) data photographed by a digital still camera (DSC), (2) data captured from a digital video (DV) system, and (3) scanning data of a silver-salt photograph film or print. These data may be used individually or in combination.

The accounting unit is a unit by which the accounting is performed according to a used volume. Examples of the accounting unit include a so-called coin kit and a bill-receiving unit.

The image-forming system for the electrophotogaraphy is connected with a personal data assistant, a network or a internet and becomes communicable with a connected unit.

Examples of the image-forming apparatus in the image-forming system for the electrophotography according to the present invention include a unit Docu Color 125 PF (manufactured and sold by Fuji Xerox Co., Ltd.).

An apparatus configured to fix the image by smoothing the image surface shown in FIG. 3 can be used in an image-forming apparatus (e.g., a full-color laser printer DCC-500 (manufactured and sold by Fuji Xerox Co., Ltd.)) shown in FIG. 2 by converting the image-forming apparatus to a part of the belt fixing in the image-forming apparatus and the converted image-forming apparatus can be used as an image-forming apparatus in the image-forming system for the electrophotography according to the present invention. According to the same process as the above-noted image-forming process according to the present invention, the image can be formed in the above-noted image receiving sheet for the electrophotography.

According to the image-forming system for the electrophotography according to the present invention, by using the image receiving sheet for the electrophotography according to the present invention, not only an electrophotograph print having a high gloss level and the same image quality as the silver salt photograph can be easily obtained on the demand of the user at a photo shop, but also the obtained electrophotograph print can suppress the lowering of the gloss level due to an environmental change after the image-forming, so that an electrophotograph print which can maintain the same high image quality as that of the silver salt photograph, can be effectively and easily obtained.

Hereinbelow, with referring to Examples, the present invention is explained in detail and the following Examples should not be construed as limiting the scope of the present invention.

### EXAMPLE 1

### Production of Image-Receiving Sheet for Electrophotography

—Preparing of Raw Paper—

A pulp slurry was prepared by mixing 25% by mass of a pulp material obtained by beating LBKP (broad-leaf kraft pulp, bleaching pulp) made from acacia to 30 ml of Canadian Standard Freeness using a disk refiner with 75% by mass of a pulp material obtained by beating LBKP (broad-leaf kraft pulp, bleaching pulp) made from aspen to 300 ml of Canadian Standard Freeness using a disk refiner, relative to 100% by mass of the pulp slurry. The prepared pulp slurry was mixed with 1.3% by mass of a cationic starch (manufactured and sold by Nihon N.S.C. Company; trade name: CATO 304 L), 0.145% by mass of an anionic polyacrilamide (manufactured and sold by Seiko P.M.C. Corporation; trade name: Polyacron ST-13), 0.285% by mass of an alkyl ketene dimmer (manufactured and sold by Arakawa Chemical Industries, Ltd.; trade name: Sizepine K), 0.32% by mass of polyamidepolyamineepichlorohydrin (manufactured and sold by Arakawa Chemical Industries, Ltd.; trade name: Arafix 100) and 0.12% by mass of an anti-forming agent, relative to 100% by mass of the pulp slurry, thereby preparing a pulp slurry for producing the raw paper.

Next, the prepared pulp slurry was subjected to paper making using a Fourdrinier paper-making machine to obtain a paper web and the obtained paper web was pressed onto a dryer cylinder through a dryer canvas to dry the web, thereby obtaining the raw paper. The tensile force of the dryer canvas was preset at 1.6 kg/cm. The both surface of the obtained raw paper was coated with a polyvinyl alcohol (manufactured and sold by Kuraray Co., Ltd.; trade name: KL-118) in an amount of 1 g/m² to dry the obtained raw paper and the dried raw paper was subjected to a calendar treatment.

The raw paper was made in such a manner that the raw paper has a basis weight of 163 g/m² and a thickness of 160 μm.

—Preparing of Support—

On the back surface of the obtained raw paper, a polyethylene resin having a composition (55% by mass of HDPE and 45% by mass of LDPE) shown in Table 2 was laminated by single-layer extrusion using a cooling roll having a surface matt roughness of 10 μm at a molten delivered film temperature of 310° C. and a line speed of 250 m/min, thereby disposing a back surface polyethylene layer having a thickness of 22 μm.

TABLE 2

| | MFR(g/10 min) | Density (g/cm³) | Content (% by mass) |
|---|---|---|---|
| HDPE | 12 | 0.967 | 55 |
| LDPE | 3.5 | 0.923 | 45 |

wherein HDPE means a high density polyethylene and LDPE means a low density polyethylene. MFR and Density are properties of HDPE and LDPE and Content is the composition of the above-noted polyethylene resin.

Next, on the surface of the raw paper (on which the toner image-receiving layer is disposed), a mixture of an LDPE masterbatch pellet having a composition shown in Table 3 and an LDPE masterbatch pellet comprising a 5% by mass ultramarine blue, wherein the mixture has a composition shown in Table 4 was laminated by single-layer extrusion using a cooling roll having a surface matt roughness of 0.7 μm at a line speed of 250 m/min, thereby disposing a surface polyethylene layer having a thickness of 29 μm.

Thereafter, the surface and the back surface of the raw paper were subjected to a corona discharge of respectively 18 kW and 12 kW and on the surface and the back surface of the raw paper, an undercoating layer of a gelatin having a dry mass of respectively 0.06 g/cm² and 0.038 g/cm² was respectively disposed, thereby obtaining a support.

TABLE 3

| Composition | Content (% by mass) |
|---|---|
| LDPE(ρ = 0.921 g/cm³) | 37.98 |
| Titanium dioxide in form of anatase | 60.00 |
| Zinc stearate | 2.00 |
| Antioxidant | 0.02 |

TABLE 4

| Composition | Content (% by mass) |
|---|---|
| LDPE(ρ = 0.921 g/cm³) | 67.7 |
| Titanium dioxide in form of anatase | 30.0 |
| Zinc stearate | 2.0 |
| Ultramarine blue | 0.3 |

—Preparing of Coating Liquid for Intermediate Layer—

100 Parts by mass of a water-dispersible acrylic resin (manufactured and sold by Seiko P.M.C. Corporation; trade name: Hiros X-XE 240; having a glass transition temperature (Tg) of 15° C., an acid value of 82, a solid content of 42% by mass, an ammonia content of 0.98%), 100 parts by mass of a water-dispersible acrylic resin (manufactured and sold by Johnson Polymer Corporation; trade name: PDX 7325; having a glass transition temperature (Tg) of 66° C., an acid value of 61, a solid content of 45% by mass, an ammonia content of 0.77%), 2.5 parts by mass of a polyethylene oxide (manufactured and sold by Meisei Chemical Works, Ltd.; trade name: ALKOX R 1000), 1.2 parts by mass of an anionic surfactant (manufactured and sold by NOF Corporation; trade name: Rapisol A 90) and 60 parts by mass of an ion-exchanged water were mixed and stirred, thereby preparing a coating liquid for the intermediate layer.

<Preparing of Coating Liquid for Toner Image-Receiving Layer>

—Preparing of Titanium Dioxide Dispersion—

48 Parts by mass of titanium dioxide (manufactured and sold by Ishihara Sangyo Kaisha, Ltd.; trade name: TIPAQUE R780-2), 6 parts by mass of a polyvinyl butyral (manufactured and sold by Kuraray Co., Ltd.; trade name: PVA 205 C), 0.6 parts by mass of a surfactant (manufactured and sold by Kao Corporation; trade name: DEMOL EP), 0.06 parts by mass of a carbon black (manufactured and sold by Mitsubishi Chemical Corporation, trade name: 10 B) and 65.6 parts by mass of an ion-exchanged water were mixed and the resultant mixture was subjected to dispersing using a dispersing machine (manufactured and sold by Nihon Seiki Seisakusho Co., Ltd.; trade name: NBK-2), thereby preparing a titanium dioxide dispersion.

<Preparing of Coating Liquid for Toner Image-Receiving Layer>

15.5 Parts by mass of the above-prepared titanium dioxide dispersion, 10 parts by mass of a carnauba wax aqueous dispersion (manufactured and sold by Chukyo Yushi Co., Ltd.; trade name: Cellosol 524), 200 parts by mass of an aqueous dispersion of a polyester resin (as a self-dispersible water-dispersible polymer) (having a solid content of 35% by mass, an acid component of terephthalic acid, an, alcohol component of ethylene glycol, neopentyl glycol and an ethylene oxide adduct of a bisphenol A, a counter cathion of NH₄⁺ ion, an acid value of 18, a volume average particle diameter of 150 nm and a number average molecular weight of 6,000), 4.8 parts by mass of a polyethylene oxide (as a water-soluble polymer) (manufactured and sold by Meisei Chemical Works, Ltd.; trade name: ALKOX R 1000), 1.5 parts by mass of an anionic surfactant (manufactured and sold by NOF Corporation; trade name: Rapisol A 90), 1.8 parts by mass of particles of a matting agent (manufactured and sold by Souken Chemical Co., Ltd.; trade name: MX 2,000) and 128.7 parts by mass of an ion-exchanged water were mixed, thereby preparing a coating liquid for the toner image-receiving layer.

The above-noted aqueous dispersion of a polyester resin has a glass transition temperature (Tg) of 70° C., the above-noted polyethylene oxide has a melting point of 66° C., the above-noted carnauba wax aqueous dispersion has a melting point of 83° C. and the matting agent (MX 2,000) comprises a crosslinked form of a polymethylmethacrylate.

—Disposing of Toner Image-Receiving Layer and Intermediate Layer—

On the above-prepared support, by coating the support with both the above-prepared coating liquid for the intermediate layer and the above-prepared coating liquid for the toner image-receiving layer, which were filtered by a 400-mesh filter (under the condition where the effective filtration accuracy is 40 μm or less), simultaneously, the intermediate layer and the toner image-receiving layer were disposed simultaneously using a slidegieser so that the intermediate layer has an amount of 5.0 g/m² (in terms of a dry mass) and the toner image-receiving layer has an amount of 7.5 g/m² (in terms of a dry mass).

After the coating, the intermediate layer and the toner image-receiving layer were dried by blowing high temperature (of 100° C.) air onto the surface of the layers respectively, thereby producing the toner image-receiving sheet for the electrophotography of Example 1, so that the toner image-receiving layer and the intermediate layer had a thickness of respectively 7 μm and 5 μm.

—Image-Forming—

In the above-produced image-receiving sheet for the electrophotography of Example 1, an uniform image having a size of 10 cm×10 cm in maximum density of black was formed under the following conditions and in the atmosphere having a temperature of 23° C. and a relative humidity of 55% RH using an image-forming apparatus (manufactured and sold by Fuji Xerox Co., Ltd.; trade name: DocuCentre Color 500 CP) shown in FIG. 2 in which the original fixing part was converted to the fixing unit of the image by smoothing the image surface shown in FIG. 3 and the formed image was subjected to the treatment of fixing by smoothing of the image under the following conditions.

—Belt—

Support in the composition of the belt: a polyimide (PI) film having a width of 50 cm and a thickness of 80 μm.

Mold-releasing layer of the belt (produced in the following 2 types):

(1) SIFEL

The mold-releasing layer of the belt was disposed on the above-noted support as a film (having a thickness of 50 μm) of a fluorocarbonsiloxane rubber produced by vulcanization-curing a fluoroelastomer (manufacture and sold by Shin-Etsu Chemical Co., Ltd.; trade name: SIFEL 610) which is a precursor of a fluorocarbonsiloxane rubber.

(2) Silicone Rubber

The mold-releasing layer of the belt was disposed on the above-noted support as a film (having a thickness of 50 μm) of a silicone rubber DY35-796 AB (manufacture and sold by Dow Corning Toray Silicone Co., Ltd.).

—Process for Heating and Pressing—

Temperature of the heating roller: 140° C.

Nip pressure: 130 N/cm²

—Process for Cooling—

Cooling unit: the length of the heat sink is 80 mm

Conveying speed: 53 mm/second

### EXAMPLE 2 AND COMPARATIVE EXAMPLES 1 TO 5

In substantially the same manner as in Example 1, except that the particles of the matting agent which was used for the preparing of the coating liquid for the toner image-receiving layer in Example 1 were changed to those shown in the following Table 5, the toner image-receiving sheets for the electrophtography of Example 2 and Comparative Examples 1 to 5 were respectively produced and in substantially the same manner as in Example 1, in the produced toner image-receiving sheets, the image was formed.

TABLE 5

| | Particles (matting agent) |
|---|---|
| Example 1 | MX2000 (Souken Chemical Co., Ltd.) |
| Example 2 | XX08S (Sekisui Plastics Co., Ltd.) |
| Compara. Ex. 1 | LE1080 (Sumitomo Seika Chemicals Co., Ltd.) |
| Compara. Ex. 2 | EA209 (Sumitomo Seika Chemicals Co., Ltd.) |
| Compara. Ex. 3 | CL2080 (Sumitomo Seika Chemicals Co., Ltd.) |
| Compara. Ex. 4 | SBX-12 (Sekisui Plastics Co., Ltd.) |
| Compara. Ex. 5 | — |

wherein, as a component of each matting agent, XX08S comprises a crosslinked PMMA resin, LE 1080 comprises a polyethylene resin, EA 209 comprises an ethyl acrylate resin, CL 2080 comprises a polyethylene resin and SBX-12 comprises a crosslinked polystyrene resin.

### EXAMPLE 3

In substantially the same manner as in Example 1, except that the aqueous dispersion of a polyester resin as a self-dispersible water-dispersible polymer in Example 1 was changed to a self-dispersible water-dispersible polyester resin emulsion (manufactured and sold by Unitika Ltd.; trade name: Elitel KZA-1449; having a solid content of 35% by mass, a glass transition temperature (Tg) of 46° C., a number average molecular weight of 6,500, a molecular-weight distribution of 3.2, a volume average diameter of 43 nm and a flow beginning temperature of 100.4° C.), the toner image-receiving sheet for the electrophtography of Example 3 was produced and in substantially the same manner as in Example 1, in the produced toner image-receiving sheet, the image was formed.

### EXAMPLE 4

In substantially the same manner as in Example 1, except that the aqueous dispersion of a polyester resin as a self-dispersible water-dispersible polymer in Example 1 was changed to a self-dispersible water-dispersible polyester resin emulsion (having a solid content of 35% by mass, an acid component of terephthalic acid and isophthalic acid, an alcohol component of ethylene glycol, neopentyl glycol and an ethylene oxide adduct of a bisphenol A, a counter cathion of NH₄⁺ ion, a glass transition temperature (Tg) of 72° C., a volume average particle diameter of 135 nm and a number average molecular weight of 6,500), the toner image-receiving sheet for the electrophtography of Example 4 was produced and in substantially the same manner as in Example 1, in the produced toner image-receiving sheet, the image was formed.

With respect to the obtained toner image-receiving sheets for the electrophtography of Examples 1 to 4 and Comparative Examples 1 to 5 respectively, a particle size distribution of the matting agent particles was respectively measured according to the following method.

—Particle Size Distribution—

With respect to the obtained toner image-receiving sheets for the electrophtography of Examples 1 to 4 and Comparative Examples 1 to 5 respectively, a particle size distribution of the matting agent particles was respectively measured by a method comprising measuring the arithmetic standard deviation and arithmetic volume average particle diameter of the above-noted matting agent alone using a particle diameter measuring apparatus (manufactured and sold by Horiba, Ltd.; trade name: LA 920) under the condition where a ultrasonic dispersing time was 2 minutes, and calculating the particle size distribution from the calculated arithmetic standard deviation and arithmetic volume average particle diameter according to the following equation:
Particle size distribution=(Arithmetic standard deviation)/(Arithmetic volume average particle diameter).

The result of the measurement of the particle size distribution is shown together with the result of the measurement of the volume average particle diameter of the matting agent particles in Table 6.

<Evaluation of Performance>

With respect to the coating liquids for the toner image-receiving layers of the toner image-receiving sheets for the electrophtography produced in Examples 1 to 4 and Comparative Examples 1 to 5 respectively, the filtering characteristics were evaluated respectively according to the following method.

With respect to the toner image-receiving sheets for the electrophtography produced in Examples 1 to 4 and Comparative Examples 1 to 5 respectively, the adhesion resistance was evaluated respectively according to the following method. With respect to the toner image-receiving sheets for the electrophtography after the image-forming produced in Examples 1 to 4 and Comparative Examples 1 to 5 respectively, the quality of the formed image was evaluated respectively according to the following method.

The result of the evaluation is shown in Table 6.

—Evaluation of Filtering Characteristics—

1,000 g of the coating liquid for the toner image-receiving layer were subjected to the filtration using a 400-mesh filter (under the condition where the effective filtration accuracy is 40 μm or less) having a diameter of 15 cm and the filtering properties were evaluated according to the following criteria

[Evaluation Criteria]

A the coating liquid can pass smoothly through the filter.

B on the way, the filter is clogged by the coating liquid and the filtration can be no more performed.

—Evaluation of Adhesion Resistance—

The sample (having a size of 4 cm×5 cm) of the toner image-receiving sheets for the electrophtography produced in Examples 1 to 4 and Comparative Examples 1 to 5 respectively was cut out respectively. One piece of the sample was put on another piece of the sample in such a manner that the back surface of a sample is contacted with the surface of another piece and on the two pieces of the sample, a weight having a size of 3.5 cm×3.5 cm and a weight of 500 g was put. The weighted two pieces of the sample was left in an atmosphere having a temperature of 40° C. and a relative humidity of 80% RH for 3 days. Thereafter, the pressed-onto 2 pieces were peeled off and the contacted surface was visually observed, thereby evaluating the adhesion resistance of the toner image-receiving sheet according to the following criteria.

[Evaluation Criteria]

A there was no adhesion trace.

B there was an adhesion trace only at the edge of the sheet.

C there was an adhesion trace at an inner part on the surface of the sheet.

—Evaluation of Image—

The quality of the formed image in the toner image-receiving sheets for the electrophtography produced in Examples 1 to 4 and Comparative Examples 1 to 5 respectively was visually observed and evaluated according to the following criteria.

TABLE 6

| | Volume Average | Thickness of Toner | | | | |
|---|---|---|---|---|---|---|
| | Particle | Image-Receiving | Particle Size | Filtering | Adhesion | Image |
| | Diameter (μm) | Layer (μm) | Distribution | Properties | Resistance | Quality |
| Ex. 1 | 20.6 | 7 | 0.26 | A | A | B |
| Ex. 2 | 17.4 | 7 | 0.32 | A | A | A |
| Ex. 3 | 20.6 | 7 | 0.26 | A | A | B |
| Ex. 4 | 20.6 | 7 | 0.26 | A | A | B |
| Compara. Ex. 1 | 7.5 | 7 | 0.57 | C | B | B |
| Compara. Ex. 2 | 8.3 | 7 | 0.67 | C | A | C |
| Compara. Ex. 3 | 10.8 | 7 | 0.48 | C | A | C |
| Compara. Ex. 4 | 12.0 | 7 | 0.48 | C | A | C |
| Compara. Ex. 5 | — | 7 | — | A | C | A |

From the result of Table 6, it is confirmed that the coating liquids for the toner image-receiving layer produced in Examples 1 to 4 are more excellent in the filtering properties than the coating liquids for the toner image-receiving layer produced in Comparative Examples 1 to 5.

It is confirmed that the toner image-receiving sheets for the electrophtography produced in Examples 1 to 4 are more excellent in the adhesion resistance and the image quality than the toner image-receiving sheets for the electrophtography produced in Comparative Examples 1 to 5.

It is confirmed that since, in Comparative Example 5, the coating liquid for the toner image-receiving layer comprises no matting agent, the coating liquid is excellent in the filtering properties and the formed image is excellent in the quality, however, the adhesion resistance of the sheet is extremely poor.

### INDUSTRIAL APPLICABILITY

In the toner image-receiving sheet for the electrophtography according to the present invention, the image having a high quality can be formed and the adhesion resistance, particularly the adhesion resistance during the storage of the sheet before the image-forming can be improved, so that the toner image-receiving, sheet for the electrophtography according to the present invention can be applied to an image-forming apparatus of high speed-fixing.

According to the manufacturing method of the toner image-receiving sheet for the electrophtography according to the present invention, a toner image-receiving sheet for the electrophtography which is excellent in the adhesion resistance and the quality of the formed image and in which the coating liquid for the toner image-receiving layer has excellent filtering properties and has easiness to remove foreign matters therefrom can be effectively produced.

According to the image-forming process according to the present invention, even if by using an image-forming apparatus equipped with no fixing oil, not only the release characteristics of the image-receiving sheet for the electrophotography and the toner can be suppressed or the off-set of the image-receiving sheet for the electrophotography and the toner components can be prevented, so that a stable feeding of the image-receiving sheet can be obtained, but also an image which is excellent in anti-crazing due to humidity change properties, anti-adhesion properties, anti-crazing properties and gloss level, and has a similar high image-quality to a print of a silver salt photography can be formed.

According to the image-forming system for the electrophotography according to the present invention, by using the image receiving sheet for the electrophotography according to the present invention, not only an electrophotograph print having a high gloss level and the same image quality as the silver salt photograph can be easily obtained on the demand of the user at a photo shop, but also the obtained electrophotograph print can suppress the lowering of the gloss level due to an environmental change after the image-forming, so that an electrophotograph print which can maintain the same high image quality as that of the silver salt photograph, can be effectively and easily obtained.

1. An image-receiving sheet for the electrophotography comprising:
a support, and
a toner image-receiving layer which is disposed on at least one surface of the support and comprises a polymer used for producing the toner image-receiving layer,
wherein the image-receiving sheet for the electrophotography comprises particles projecting out of the outermost surface of the toner image-receiving sheet for the electrophotography, and the particle size distribution (standard deviation/volume average particle diameter) is 0.4 or less.

2. The image-receiving sheet for the electrophotography according to claim 1,
wherein the image-receiving sheet for the electrophotography further comprises an intermediate layer between the support and the toner image-receiving layer, and the intermediate layer comprises a polymer used for producing the intermediate layer having at least any one of a glass transition temperature (Tg) and a melting point which are the temperature for the image-fixing or lower.

3. The image-receiving sheet for the electrophotography according to claim 1,
wherein the volume average particle diameter of the particles is 3 μm to 30 μm.

4. The image-receiving sheet for the electrophotography according to claim 2,
wherein the glass transition temperature (Tg) of the polymer used for producing the toner image-receiving layer is 35° C. or higher and is higher than the glass transition temperature (Tg) of the polymer used for producing the intermediate layer and the toner image-receiving layer comprises less than 40% by mass of a pigment, based on the mass of the polymer used for producing the toner image-receiving layer.

5. The image-receiving sheet for the electrophotography according to claim 2,
wherein the glass transition temperature (Tg) of the polymer used for producing the toner image-receiving layer is 35° C. or higher and is higher than the glass transition temperature (Tg) of the polymer used for producing the intermediate layer and the toner image-receiving layer comprises no pigment.

6. The image-receiving sheet for the electrophotography according to claim 2,
wherein the polymer used for producing the intermediate layer is a hydrophilic thermoplastic resin.

7. The image-receiving sheet for the electrophotography according to claim 6,
wherein the hydrophilic thermoplastic resin is a water-dispersible acrylic resin.

8. The image-receiving sheet for the electrophotography according to claim 1,
wherein the toner image-receiving layer comprises a water-dispersible emulsion having a volume average particle diameter of 20 nm or more and a water-soluble polymer having a weight average molecular weight (M_{w}) of 400,000 or less.

9. The image-receiving sheet for the electrophotography according to claim 8,
wherein the water-dispersible emulsion is a water-dispersible polyester emulsion.

10. The image-receiving sheet for the electrophotography according to claim 9,
wherein the water-dispersible polyester emulsion is a self-dispersible water-dispersible polyester emulsion.

11. The image-receiving sheet for the electrophotography according to claim 10,
wherein the self-dispersible water-dispersible polyester emulsion satisfies the following properties (1) to (4):
(1) The number-average molecular weight (Mn) is 5,000 to 10,000,
(2) The molecular-weight distribution (weight average molecular weight/number average molecular weight) is 4 or less,
(3) The glass transition temperature (Tg) is 40° C. to 100° C., and
(4) The volume average particle diameter is 20 nm to 200 nm.

12. The image-receiving sheet for the electrophotography according to claim 8,
wherein the water-soluble polymer is a polyethylene oxide.

13. The image-receiving sheet for the electrophotography according to claim 1,
wherein the support comprises:
a raw paper, and
polyolefin layers disposed on the both surfaces of the raw paper.

14. The image-receiving sheet for the electrophotography according to claim 1,
wherein the toner image-receiving layer comprises a natural wax having an amount of 0.1 g/m² to 4 g/m² in the toner image-receiving layer.

15. The image-receiving sheet for the electrophotography according to claim 14,
wherein the natural wax is at least one selected from the group consisting of a vegetable wax, an animal wax, a mineral wax and a petroleum wax.

16. The image-receiving sheet for the electrophotography according to claim 15,
wherein the vegetable wax is a carnauba wax having a melting point of 70° C. to 95° C.

17. The image-receiving sheet for the electrophotography according to claim 15,
wherein the mineral wax is a montan wax having a melting point of 70° C. to 95° C.

18. A manufacturing method of the image-receiving sheet for the electrophotography comprising:
coating the support with a coating liquid used for producing the toner image-receiving layer,
wherein the image-receiving sheet for the electrophotography is the image-receiving sheet for the electrophotography according to claim 1.

19. The manufacturing method of the image-receiving sheet for the electrophotography according to claim 18,
wherein the coating liquid used for producing the toner image-receiving layer comprises particles having a particle size distribution (standard deviation/volume average particle diameter) of 0.4 or less, and is filtered.

20. The manufacturing method of the image-receiving sheet for the electrophotography according to claim 19,
wherein the filtration is performed under the condition where the effective filtration accuracy is not more than 40 gm.

21. An image-forming process comprising:
forming a toner image in an image-receiving sheet for the electrophotography according to claim 1, and
fixing the toner image formed in the forming of the toner image by smoothing the surface of the toner image.

22. The image-forming process according to claim 21,
wherein the fixing of the toner image by smoothing the surface of the toner image is performed by heating, pressuring and cooling the toner image and by peeling the image-receiving sheet from the belt using an apparatus configured to fix the toner image by smoothing the surface of the toner image which is equipped with a heating-pressing unit, a belt and a cooling unit.

23. The image-forming process according to claim 21,
wherein on the surface of the belt, a fluorocarbon siloxane rubber layer is disposed.

24. The image-forming process according to claim 21,
wherein on the surface of the belt, a silicone rubber layer is disposed and on the surface of the silicone rubber layer, a fluorocarbon siloxane rubber layer is disposed.

25. The image-forming process according to claim 23,
wherein a fluorocarbon siloxane rubber has in the backbone chain thereof at least one of a perfluoroalkyl ether group and a perfluoroalkyl group.

26. An image-forming system for the electrophotography comprising:
a providing unit of the information from the user into an image-forming apparatus, and
an image-forming apparatus equipped with an apparatus configured to fix the toner image by smoothing the surface of the toner image which comprises:
a heating-pressuring unit,
a belt, and
a cooling unit,
wherein using the image-receiving sheet for the electrophotography according to claim 1, the image is formed.

27. The image-forming system for the electrophotography comprising:
an accounting unit by which the accounting is performed according to an used volume,
wherein the image-forming system for the electrophotography is the image-forming system for the electrophotography according to claim 26.

28. The image-forming system for the electrophotography according to claim 26,
wherein on the surface of the belt, a fluorocarbon siloxane rubber layer is disposed.

29. The image-forming system for the electrophotography according to
claim 26,
wherein on the surface of the belt, a silicone rubber layer is disposed and on the surface of the silicone rubber layer, a fluorocarbon siloxane rubber layer is disposed.

30. The image-forming system for the electrophotography according to claim 28,
wherein a fluorocarbon siloxane rubber has in the backbone chain thereof at least one of a perfluoroalkyl ether group and a perfluoroalkyl group.
